(19) United States
(12) Patent Application Publication
(10) Pub. No.: US 2021/0049724 A1
(43) Pub. Date: Feb. 18, 2021

(54) PASSENGER HANDLING SYSTEM AND METHOD

(71) Applicant: AirboardX Pty Ltd, North Sydney, NSW (AU)

(72) Inventor: William MORRIS, Cammeray, NSW (AU)

(21) Appl. No.: 17/041,931

(22) PCT Filed: Mar. 27, 2019
(86) PCT No.: PCT/AU2019/000040

§ 371 Date: Sep. 25, 2020

(30) Foreign Application Priority Data
Mar. 27, 2018 (AU) 2018901017
Jul. 19, 2018 (AU) 2018902613
Aug. 8, 2018 (AU) 2018902894
Aug. 27, 2018 (AU) 2018903150
Nov. 23, 2018 (AU) 2018904470
Jan. 15, 2019 (AU) 2019900120

(51) Int. Cl. G06Q 50/30; G06Q 10/02; G06Q 30/02; G07C 11/00; G06K 19/06

(52) U.S. Cl. CPC G06Q 50/30; G06Q 10/02; G07C 2011/04; G07C 11/00; G06K 19/06037; G06Q 30/0204

(57) ABSTRACT

The present invention relates to a boarding system and method which include one or more repositories, a processor and one or more electronic devices. The one or more repositories is designed for storing passenger, booking and passenger carrier characteristics of a specific scheduled journey in a passenger carrier. The processor is adapted to calculate grouping of one or more passengers boarding the passenger carrier, an optimised boarding order, and boarding times for every group of passengers based on one or more of said characteristics. Each passenger or group of passengers is notified to go on board through the one or more electronic devices.

### TECHNICAL FIELD

The present invention broadly relates to a passenger handling system and method, particularly but not limited to those relating to boarding of a passenger carrier.

### BACKGROUND OF THE INVENTION

With the growth in the number of international and domestic flights and passengers, the time it takes for passengers to board an aircraft is of significant importance. This is particularly relevant as there seems to be a trend of increasing the size of some aircrafts which can now carry more than 850 passengers. The logistics of boarding such a large number of passengers onto an aircraft demands certain necessities and such a boarding exercise often results in long waiting lines followed by passengers boarding the plane in no particular sequence. Boarding of passengers in such a random manner would also inevitably lead to aisle and seat interferences thereby causing passenger agitation having to get up and down for others and bottleneck waiting while other passengers are loading their belongings.

Apart from the inconvenience for travellers, of particular concern to airlines is the turn-around time which must be minimised to enable aircrafts to maintain their schedules and avoid missing their take-off slots which is costly.

Much effort has been made by airlines to streamline boarding in order to get passengers into the aircraft expediently by minimising congestion. For instance, previous attempts have been made to use the vessel shape and size as pre-determining factors for the boarding order. Various other methods and procedures have been adopted by some airlines but they are all considered to be far from satisfactory. It would thus be highly desirable to improve the efficiency of boarding passengers on an aircraft.

It is an object of the present invention to provide a passenger handling system and method which may improve the efficiency of boarding passengers on an aircraft, or which will at least provide a useful alternative.

### SUMMARY OF THE INVENTION

The present invention arises from the recognition that the boarding process for aircrafts or any other passenger vessels may be accelerated by automation based on passenger, booking and flight characteristics to calculate and communicate an optimised boarding order and to facilitate validation of passenger credentials.

According to one aspect of the present invention, there is provided a boarding system including:

one or more repositories for storing passenger, booking and passenger carrier characteristics of a specific scheduled journey in a passenger carrier;

a processor adapted to calculate grouping of one or more passengers boarding the passenger carrier, an optimised boarding order, and boarding times for every group of passengers based on one or more of said characteristics; and

one or more electronic devices through which each passenger or group of passengers is notified to go on board.

In a preferred embodiment, the passenger carrier is an aircraft.

The passenger carrier may be any other passenger vessel such as a cruise ship, bus, ferry, passenger train or passenger space shuttle.

Preferably, grouping involves the processor allocating a reference or code to selected one or more passengers who are to board at the same time. More preferably, the reference or code includes a number. Alternatively, the reference or code includes a letter and a numeral. The number or numeral may be non-consecutive. Even more preferably, the groups of passengers are to board in a numeric order at respective calculated boarding times.

Preferably, there exists a time interval between the boarding times of any two consecutive groups. The time interval being controlled by the processor may vary depending on the flow of passengers during boarding.

Preferably, the optimised boarding order is calculated in such a way that each group of passengers is allowed a pre-determined number of rows of clear space inside the cabin during boarding based on the passenger characteristics.

Preferably, the processor is adapted to follow an algorithm which performs calculation by assessing said characteristics. More preferably, passenger characteristics include age, carry-on luggage, co-traveller information, physical or mental impairments, care requirements, vision problems, disabilities or mobility issues, travelling with wheelchairs for the elderly, travelling with prams, carriers or capsules for babies or strollers for toddlers. Passenger characteristics may also include any other access requirements which may impact on the boarding allocation and timing. Even more preferably, booking characteristics include check-in status and travel classes. Most preferably, passenger carrier characteristics include aircraft type, door access parameters, cabin layout and seat assignment.

In a preferred embodiment, the processor is programmed to allow special arrangements and orders to create more clear space and delays if and when required. For example, the processor may choose to delay any particular group's boarding in the sequence to reduce or alleviate seat or aisle interfaces or any existing congestion caused thereby. Also, the processor may allocate passenger ‘pull over’ space by delaying passenger groups with aisle seats.

Preferably, the one or more electronic devices include a smart phone, a smart watch, a tablet computer and any near-field communicated (NFC) enabled devices. More preferably, an SMS, notification or email message is sent to each passenger or group of passengers with a link to a portal or to a downloadable app. Even more preferably, the portal or app is configured so as to provide each passenger or group of passengers with a primary trigger to boarding. Most preferably, the primary trigger includes an electronic countdown to boarding facility. The countdown to boarding facility may be displayed on the electronic device of each passenger or group of passengers.

It is preferred that the SMS, notification or email message sent to each passenger or group of passengers includes a QR code adapted to enable passengers to have quick and direct access to the online portal. Generally, the system is configured to be capable of controlling the accessibility, visibility and availability of the electronic ticket, QR code and any NFC.

Preferably, the portal or app is configured to provide a visual indication of the location of each passenger or group of passengers with respect to the location of the relevant boarding gate and an indication of the time required to walk from current location of the passenger or group of passengers to the relevant boarding gate, for example, by way of utilising a satellite-based radio navigation system (generally referred to as GPS). As such, each passenger or group of passengers may be able to decide on when to start making his/her or their way to the relevant boarding gate. Even more preferably, the portal or app is configured to provide one or more of the following: public transport information, hotels or destinations information and authorised advertisements.

Preferably, the system includes automated audio equipment adapted to make public announcement of the relevant group number for boarding. The equipment is preferred to be located in the vicinity of the relevant boarding gate. The automated audio announcements are also optionally available through the online portal or app. The relevant group may be called out just before and/or periodically during boarding time intervals.

Alternatively, each passenger or group of passengers is notified through the one or more electronic devices to go to one of a plurality of communication points at which passengers are registered and coordinated based on the calculated boarding times and order at a selected time for registration and coordination in preparation for boarding.

In this alternative embodiment, each communication point may be located in a corresponding boarding bay to which a specific group of passengers is called and moves in preparation for boarding. Each group may include one or more passengers. More preferably, the location and configuration of each boarding bay are dictated by airport spatial conditions and airline and airport needs. Preferably, each communication point includes a first electronic interface adapted to facilitate automation of the boarding process by coordinating and validating passengers. On completion of passenger validation and coordination, the first electronic interface may be adapted to prompt the specific group of passengers to head towards the next stage of boarding.

Preferably, passenger validation involves an authentication subsystem which allows passenger credentials to be validated thereby confirming that an authenticating passenger is who he or she claims to be. Validation of credentials may be carried out via a barcode on a ticket or a mobile phone interface, or with finger-print or facial recognition technology.

The first electronic interface may also be configured to display inflight information and/or advertisements. Inflight information may relate to travel, entertainment, meal and duty-free and/or other consumer products or services.

Preferably, the one or more electronic devices includes one or more sizable electronic displays, each capable of displaying information in a font that can be seen at a distance. The displayed information is preferred to include a group which is currently being called so as to prompt the numbered group of passengers to go to a designated communication point. The displayed information may also include graphical directions to the designated communication point. Conveniently, the one or more electronic displays are located in the vicinity of a boarding gate. Optionally, each electronic display includes an audio facility such as a loud speaker which enables vocal announcement of the relevant number or group to be called thereby prompting the relevant passengers to board.

Optionally, the one or more electronic devices form part of a bollard. The bollard may have dual electronic displays. More preferably, multiple bollards are provided at chosen locations. Even more preferably, each of the bollards includes castor wheels which offers mobility. Most preferably, each mobile bollard is empowered by one or more rechargeable batteries. Optionally, each mobile bollard is adapted to be connected to a power point.

Additionally, the one or more electronic devices may include a mobile phone or a tablet computer which provides a second interface. Each passenger or group of passengers may be notified to go to a designated communication point at a selected time via text messaging, an online application or a tangible item such as a boarding pass. Conveniently, via text messaging, each passenger or group of passengers may be provided with a link to an App or a website which provides one or more of the following: a countdown to boarding facility, ticketing information, travel information and airport information.

Optionally, each group is called individually and independently. Alternatively, two or more groups may be combined and called as one large group.

Optionally, the boarding system may include a means capable of carrying out video object recognition so as to further control boarding timing between groups.

Preferably, the boarding system may include a user interface adapted to facilitate manual control of its functionality.

Preferably, the boarding system may include a repository adapted to enable validation of reasoning to advance or delay the boarding process.

Preferably, each electronic display includes a transponder unit adapted to interact with the mobile phone or tablet computer. More preferably, the transponder unit is configured to enable the system to identify and/or keep a track record of each passenger or group of passengers that walks underneath or past the relevant electronic display. Even more preferably, the transponder unit includes a sensor adapted to facilitate passenger counting, facial recognition and passengers' movement detection. Most preferably, the transponder unit is electronically associated with the system so as to form a feedback loop. As such, the system is capable of tracking individual passengers or groups that have missed their boarding allocation. Also, the system is capable of triggering the calling of one or more following numbers in the sequence.

Optionally, the system is operably associated with or integrated into a ticket verification mechanism. As such, the ticket verification mechanism is included in the feedback loop enabling information such as missed numbers or groups caused by passengers not having an operating electronic device to be conveyed to the system.

According to another aspect of the present invention, there is provided a boarding method including the steps of:

creating one or more repositories for storing passenger, booking and passenger carrier characteristics of a specific scheduled journey in a passenger carrier;

calculating grouping of one or more passengers boarding the passenger carrier, an optimised boarding order, and boarding times for every group of passengers based on one or more of said characteristics by

a processor; and

notifying each passenger or group of passengers through one or more electronic devices to go on board or to one of a plurality of the communication points at which passengers are registered and coordinated based on the calculated boarding times and order at a selected time for registration and coordination in preparation for boarding.

### BRIEF DESCRIPTION OF THE DRAWINGS

The invention may be better understood from the following non-limiting description of the preferred embodiments, in which:

FIG. 1 is a schematic diagram illustrating a digital boarding system according to one embodiment of the invention;

FIG. 2 shows a graphical user interface displaying an online application providing a passenger with different screens and information;

FIG. 3 shows the graphical user interface of FIG. 2 displaying another online application which is integrated with the online application shown in FIG. 2;

FIGS. 4a and b illustrate text messages shown on a smart phone;

FIG. 4c is an electronic display of a countdown facility on a smart phone;

FIG. 4d shows a layout of an app showing the boarding timeline;

FIG. 4e is an electronic display of the countdown facility of FIG. 4c including a QR code;

FIG. 4f is a plan view of a paper ticket bearing the QR code of FIG. 4e;

FIG. 4g is an electronic display of a map with GPS facility on a smart phone;

FIG. 4h is an electronic display of public transport information together with the text of an advertisement on a smart phone;

FIG. 5 is a schematic perspective view of communication points of the boarding system of FIG. 1;

FIG. 6 is a magnified schematic perspective view of a group of passengers standing in front of one of the communication points shown in FIG. 5;

FIG. 7 is a diagram showing a breakdown of the components of the system of FIG. 1;

FIGS. 8a to c illustrate how it works at the communication points of FIG. 5;

FIG. 9 is an example representation of a boarding pass bearing an assigned group number;

FIG. 10 is a perspective view of an electronic display located among a plurality of communication points and boarding bays;

FIGS. 11a to d are diagrams illustrating different ways of ordering passengers based on different flight characteristics;

FIG. 12a is a schematic perspective view of multiple communication points of FIG. 5 each with a first embodiment of a supporting structure;

FIG. 12b is a magnified perspective view of one of the supporting structures of FIG. 12a;

FIG. 13a is a schematic perspective view of multiple communication points of FIG. 5 each with a second embodiment of a supporting structure;

FIG. 13b is a magnified schematic view of one of the supporting structures of FIG. 13a;

FIG. 14 is a schematic perspective view of multiple communication points each with a third embodiment of a supporting structure;

FIG. 15a is a magnified perspective view of an electronic display of the system of FIG. 1 showing a group number that belongs to economy class;

FIG. 15b is a magnified perspective view of a touch screen at a communication point showing a group that belongs to first or business class;

FIG. 15c illustrates a first class passenger proceeding to boarding pass check bypassing all communication points during economy class boarding;

FIG. 16 is a process flow diagram showing a boarding method using the system of FIG. 1;

FIGS. 17a & b are perspective views illustrating an alternative embodiment of the electronic displays provided at different locations;

FIGS. 18a & b are perspective views of illustrating the electronic displays of FIGS. 17a & b each being associated with a gate;

FIG. 19 is a perspective view illustrating the solitary electronic display of FIG. 10 without any communication points;

FIG. 20 illustrates a further embodiment of a bollard including two pairs of electronic displays;

FIGS. 21a & b illustrate the bollard of FIG. 20 operably associated with gates provided at different locations;

FIG. 22 illustrates two bollards being spaced apart in the waiting area;

FIGS. 23a & b illustrate the two bollards of FIG. 22 being operably associated with gates provided at different locations;

FIG. 24a shows the two bollards of FIG. 22 provided at different locations;

FIGS. 24b & c illustrate the two bollards of FIG. 24a being operably associated with gates provided at different locations;

FIG. 25a illustrates the two bollards of FIG. 22 being located right in front of the windows;

FIG. 25b illustrates the bollards of FIG. 25a being operably associated with gates provided at the entrance to a passageway; and

FIG. 26 illustrates two electronic displays hanging from the ceiling without providing any communication points;

FIG. 27 illustrates two pairs of electronic displays hanging from the ceiling;

FIG. 28 illustrates a combination of two bollards with vertical electronic displays and two hanging electronic displays;

FIG. 29a illustrates a single bollard being place in the middle of the walkway in combination with two hanging horizontal electronic displays; and

FIG. 29b illustrates the information displayed by the electronic display of the bollard of FIG. 29a.

### DETAILED DESCRIPTION OF THE DRAWINGS

It should be noted that the system and method of the present invention have particular relevance in the context of efficient boarding of passengers onto an aircraft and hence will be herein generally described in this context. However, it is to be appreciated that the system and method may be used in the context of other applications such as in the boarding of individuals onto any other types of passenger carriers such as a cruise ship, passenger train or space shuttle. Reference to aircraft in the following description and claims is understood to provide a context for the invention but not limit the invention to that particular application.

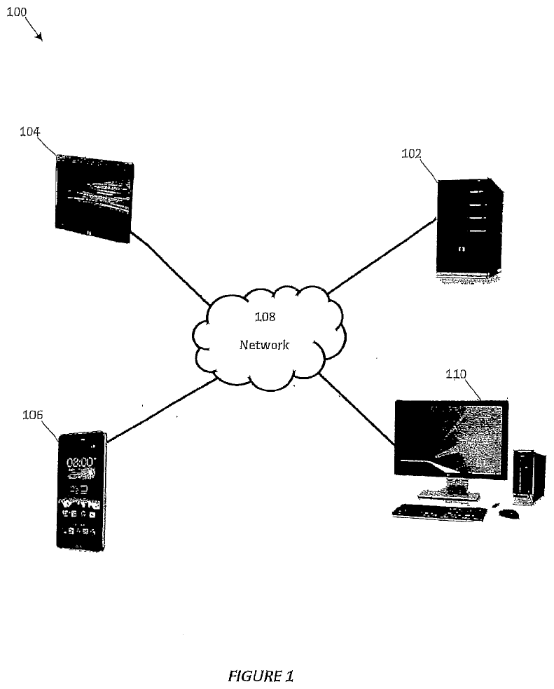

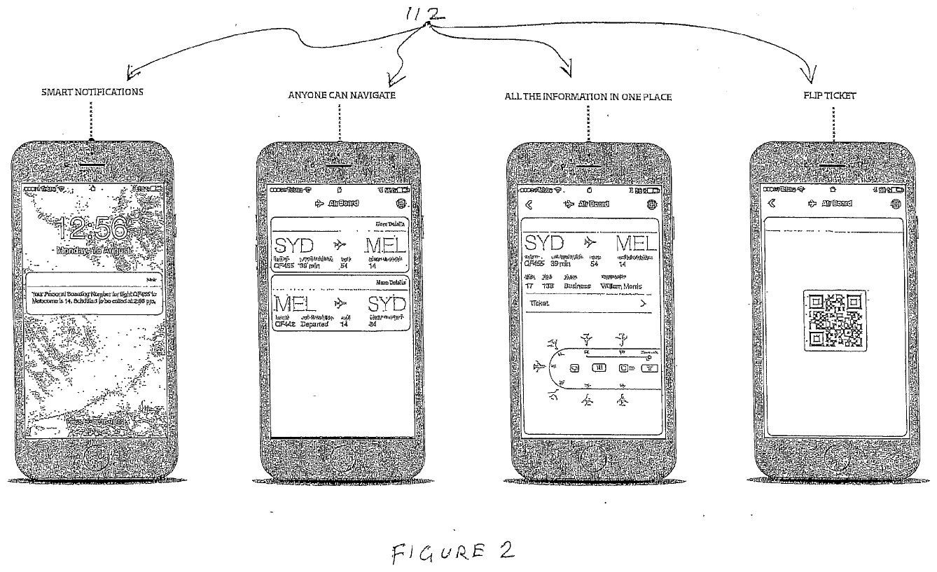

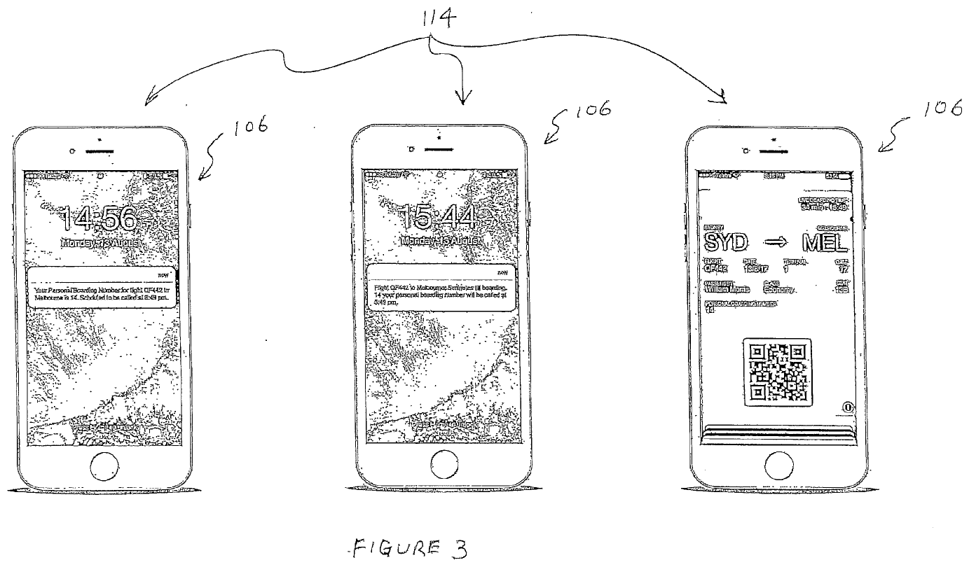

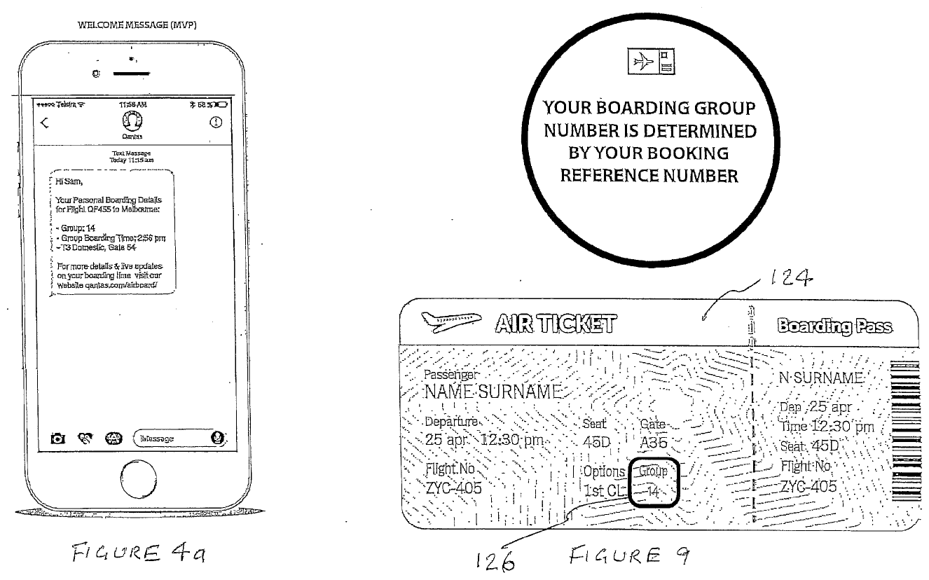

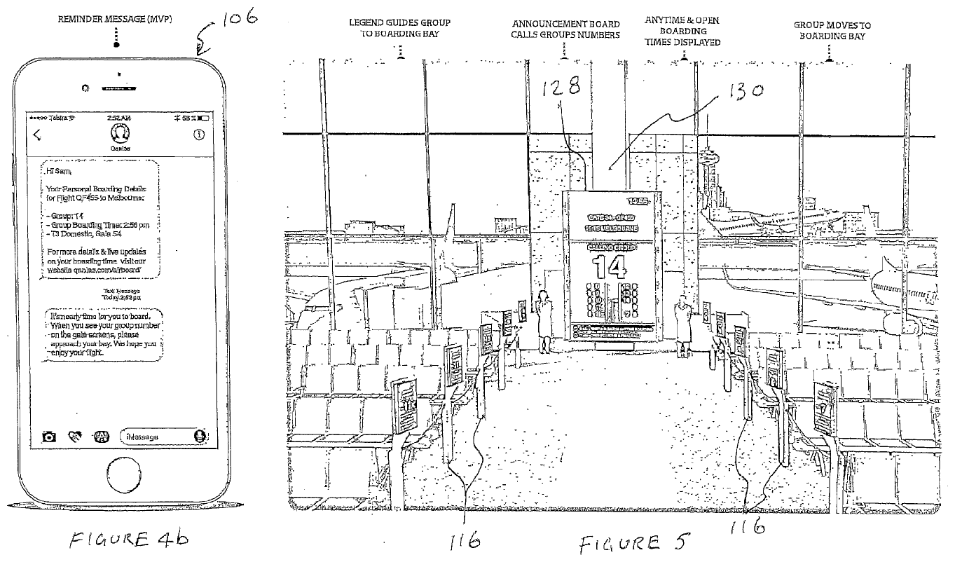

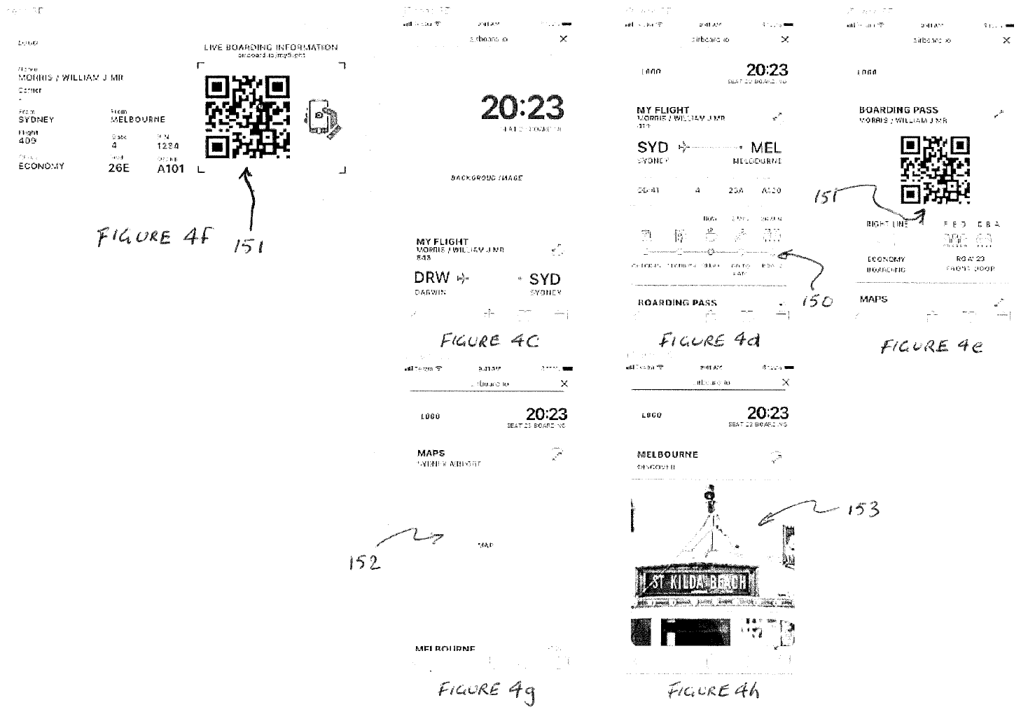

Referring to FIGS. 1 and 2, a digital passenger handling system which will generally be referred to herein as a boarding system 100 in accordance with a preferred embodiment of the present invention is shown. The system 100 has a system server 102, one or more passenger electronic devices including a tablet computer 104 and a mobile smart phone 106 (note the electronic devices may also include large electronic displays which will be described below), and a system administrator 110. The system server 102 hosts an online application 112 as configured by the system administrator 110 and as further described in detail below. The online application 112 provides a user interface 108 via the tablet computer 104 and/or mobile smart phone 106, through which a passenger can access, receive information from and interact with the online application 112 via a network 108 such as the internet. The system administrator 110 may access the server 102 via the Internet or a local network. As shown in FIG. 3, the online application 112 may also be integrated with a ticket application 114. It should also be appreciated that information may also be sent from the system administrator 110 to the passenger's mobile devices via text messaging, as illustrated in FIGS. 4a and b.

The server 102 of the boarding system 100 provides one or more repositories for storing passenger, booking and passenger carrier (ie. flight) characteristics obtained from a relevant airline. Referring to FIGS. 5 and 6, the system 100 also has a processor which is built into the server 102 in the present embodiment and a plurality of communication points 116.

Turning now to FIG. 7, the processor is designed to calculate three things, namely a) grouping of one or more passengers boarding the passenger carrier; b) an optimised boarding order and c) boarding times for every group of passengers based on the abovementioned characteristics. To this end, the processor is programmed to follow an algorithm which performs calculation by assessing the abovementioned characteristics. Specifically, passenger characteristics include age, carry-on luggage, co-traveller information, physical or mental impairments, care requirements, vision problems, disabilities or mobility issues, travelling with prams, carriers or capsules for babies or strollers for toddlers. Also, passenger characteristics may include any other access requirements which may impact on the boarding allocation and timing. The processor is designed to assign each and every passenger in the system 100 of the present invention a boarding group based on these passenger characteristics. The processor is then capable of grouping either a single passenger or multiple passengers into an order based on the booking and flight characteristics. Grouping involves the processor allocating a reference or code to selected one or more passengers who are to board at the same time. The reference or code may consist of a number or a combination of a letter and a numeral. The groups of passengers are then to board in a numeric order at respective calculated boarding times. Booking characteristics include check-in status and travel classes, for example. Passenger carrier characteristics typically include aircraft type, door access parameters, cabin layout and seat assignment. The processor is also programmed to work out the boarding times for every group of passengers based on the three aforementioned characteristics. It is contemplated that the boarding times may be adjusted to control the passenger flow during boarding or to suit a changing boarding situation depending on the circumstances at the boarding gate and on board the aircraft.

As mentioned above, the system 100 includes passenger electronic devices such as tablet computers 104, mobile smart phones 106, smart watches or any other near-field communication (NFC) enabled devices. In a preferred embodiment, an SMS message, notification or email is sent to each passenger or group of passengers with a link to a portal or to a downloadable app which is configured so as to provide each passenger or group of passengers with a primary trigger to boarding. The primary trigger has an electronic countdown to boarding facility which is displayed on the passenger's electronic device, as shown in FIG. 4c. Referring to FIG. 4d, a visual display layout on the screen of a smart phone are shown. A timeline 150 is shown on each of the layouts providing passengers with an overview of the different stages involved from check-in to boarding and an indication of where they are. Also, apart from a link to a portal or to a downloadable app, the SMS message, notification or email sent to the passenger or group of passengers includes a QR code 151, as shown in FIG. 4e. As such, each owner of a smart phone 106, for example, being a passenger, may choose to act upon the call to action. Referring to FIG. 4f, for convenience, the QR code 151 is also provided and shown on a paper ticket. As such, a passenger is able to use the Camera app that's built in to the smart phone 106 for example to scan the QR code. The QR code would then give the passenger quick and direct access to the online portal without having to type or remember any web address. Depending on the traveller type, the system 100 is capable of rendering the electronic ticket, QR code and any NFC not visible or available in the online portal or app until the access is granted. Once the system 100 triggers a passenger or a group of passengers to board, the ticket, QR code and any NFC will become visible, available or enabled. This facility offers the benefits of preventing passengers from skipping the queue and permitting the flight attendants to have total control of the timing and flow of processing passengers for boarding.

As shown in FIG. 4g, the portal or app is also configured to display a map 152 providing a visual indication of the location of each passenger or group of passengers with respect to the location of the relevant boarding gate and an indication of the time required to walk from the current location of the passenger to the relevant boarding gate, for example, by way of utilising a satellite-based radio navigation system (generally referred to as a GPS). As such, each passenger or group of passengers may be able to decide on when to start making his/her or their way to the relevant boarding gate. Turning to FIG. 4h, the portal or app is also configured to provide a visual display of one or more of the following: public transport information, hotels or destinations information 153 and authorised advertisements (not shown). The benefit of this embodiment is that only minimum gate infrastructure is required.

In the above described embodiment, the system 100 has automated audio equipment adapted to make public announcement of the relevant group number for boarding. The equipment is generally located in the vicinity of the relevant boarding gate. The automated audio announcements are also optionally available through the online portal or app. As such, a passenger with a headset would still be able to hear the any announcements through the headset being connected to a smart phone with the portal or app. The relevant group number may be called out just before and/or periodically during boarding time intervals.

In an alternative embodiments, via the mobile smart phone 106 or tablet computer 104 (or an overhead display which will be described below in detail), each passenger or group of passengers is notified to go to a designated communication point 116 at a selected time for registration and coordination via text messaging or an online application. As best shown in FIGS. 5 and 6, there is a plurality of communication points at which passengers are coordinated based on the calculated boarding times and order. As best shown in FIGS. 6 and 7, each communication point 116 is located in a corresponding boarding bay 118 to which a specific group of passengers is called and moves in preparation for boarding. The location and configuration of each boarding bay 118 are dictated by airport spatial conditions and airline and airport needs.

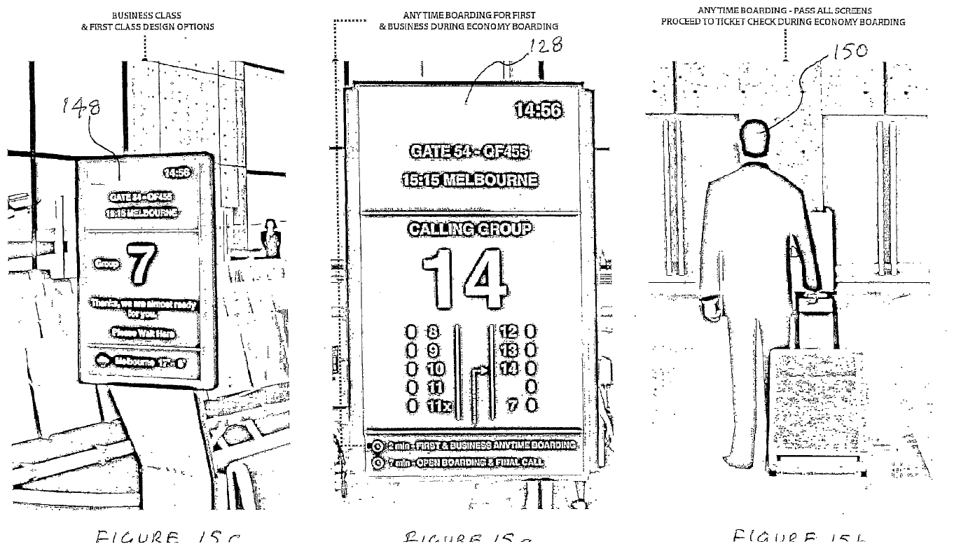

Referring to FIGS. 8a to c, in the present embodiment, each communication point 116 has an electronic interface in the form of a display touch screen 120 which is adapted to facilitate automation of the boarding process by coordinating and validating passengers. Once a passenger touches the screen 120, the system 100 registers the corresponding or associated group for boarding. The system 100 then commences the validation and coordination process. In the present example, there is a group of two passengers 122. The two passengers 122 as a group will have to wait until further instructions appear on the screen. On completion of passenger validation and coordination process, the touch screen 120 will show instructions to prompt the group of passengers 122 to head towards the boarding gate for the next stage of boarding. By this time, the passengers 122 must still hold a boarding pass 124 with a designated area 126 (see FIG. 9) where a group number representing the group to which they belong is indicated. Unless and until more advanced authentication technology is put into operation, passengers 122 are still required to present their ticket such as a boarding pass after they are prompted by the system of the present invention to board. It is contemplated that passenger validation may involve an authentication subsystem making use of facial recognition technology which allows passenger credentials to be validated thereby confirming that an authenticating passenger is who he or she claims to be. It will be appreciated that there only need to be ten communication points, for example, for each boarding gate, as once a communication point has dealt with a particular group of passenger(s), the system 100 will refresh the screen 120 to show a new group number which will invite a new group to come forward for validation and coordination. However, it should be noted that depending on the size of the aircraft being used at the gate, there might be more or less than ten communication points. For instance, an A380 might need 15 or 20 communication points whereas a 787-9 Dreamliner will need a lot less communication points. The touch screen 120 of each communication point is held by a supporting structure. Referring to FIGS. 12a and b, the supporting structure is in the form of a bollard 136 consisting of a vertical base 138 and a forwardly inclined top 140. Optionally, the supporting structure may take the form of a bollard 142 having a bifurcated top with two back to back inclined prongs 144, as shown in FIGS. 13a and b. Furthermore, as shown in FIG. 14, the supporting structure may be in the form of an upright tower 146. Optionally, the touch screen 120 may also be used as an advertising means being configured to display inflight information and/or advertisements. Inflight information may relate to travel, on board entertainment, meal, and availability and prices of duty-free and/or other consumer products and services.

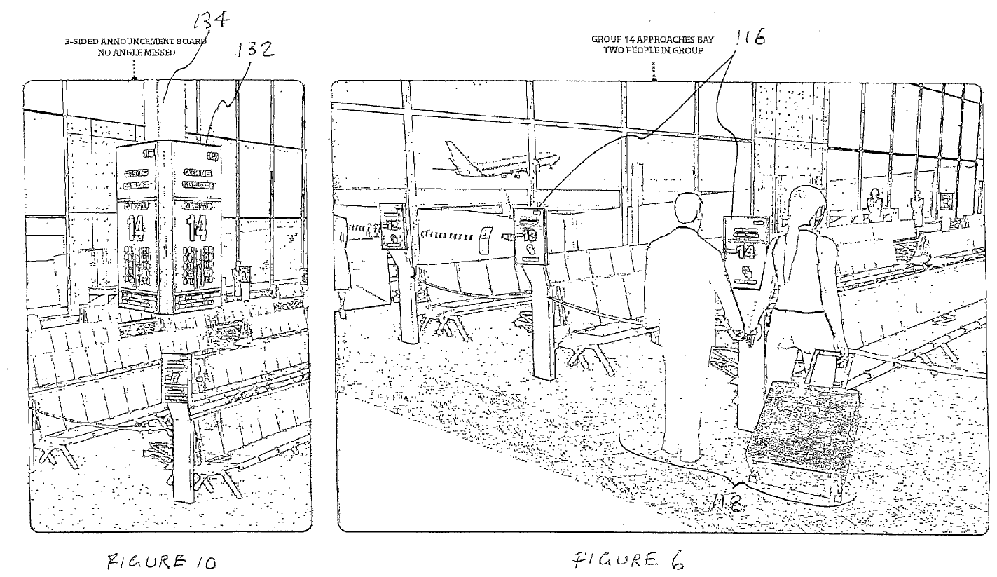

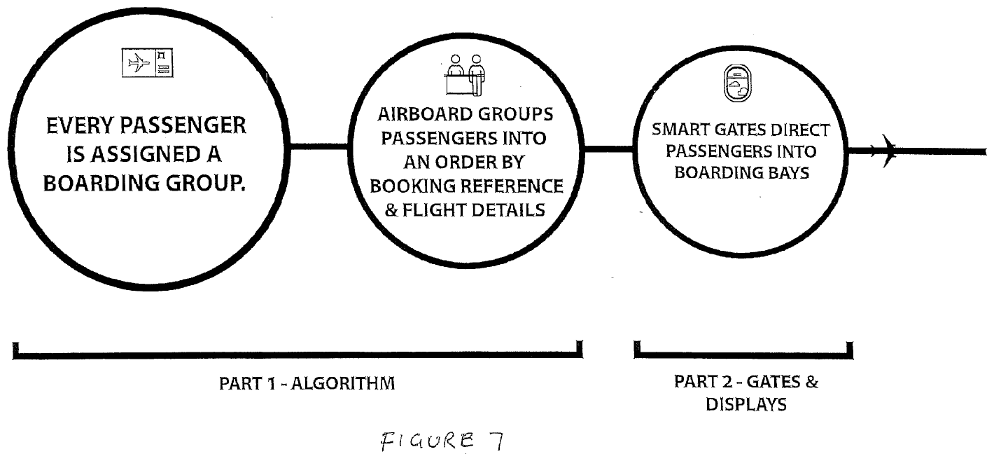

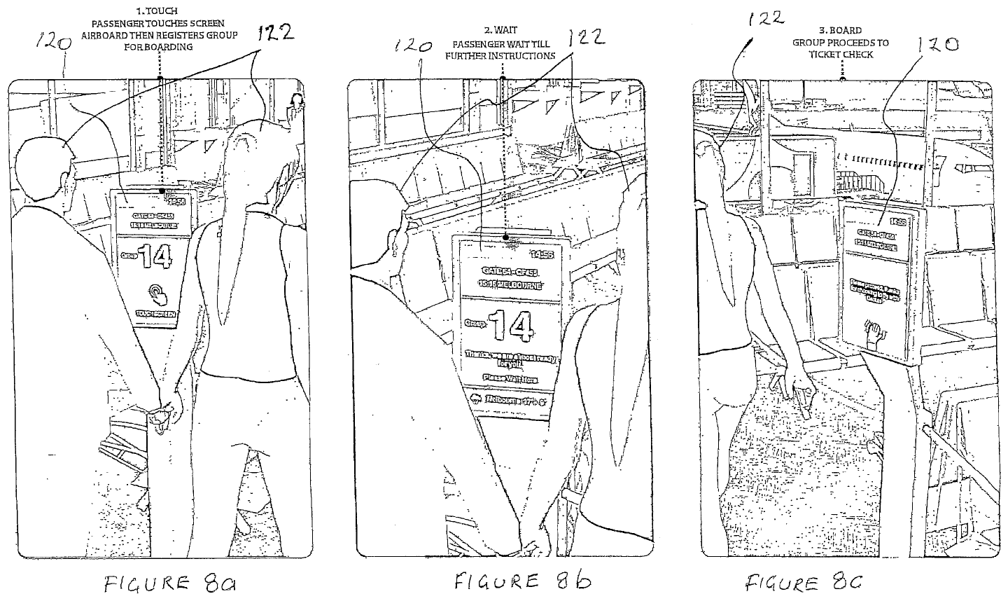

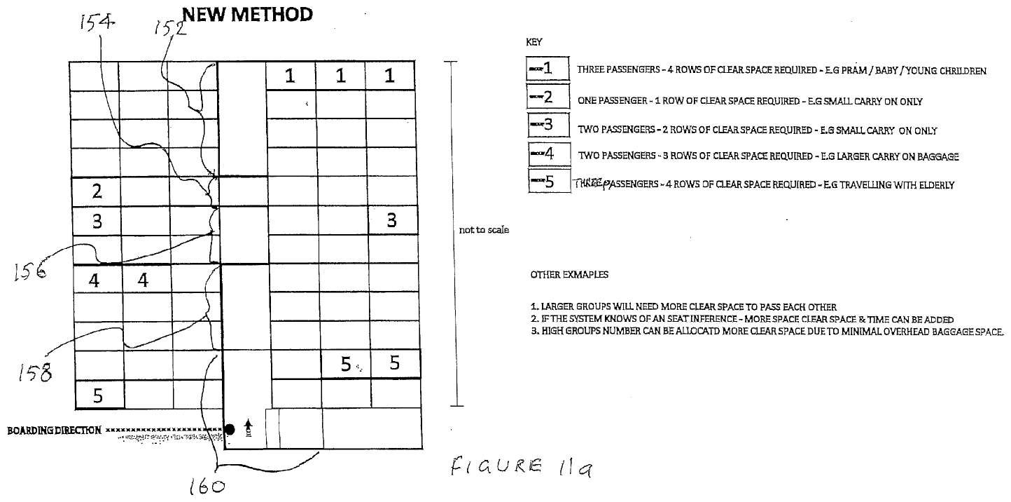

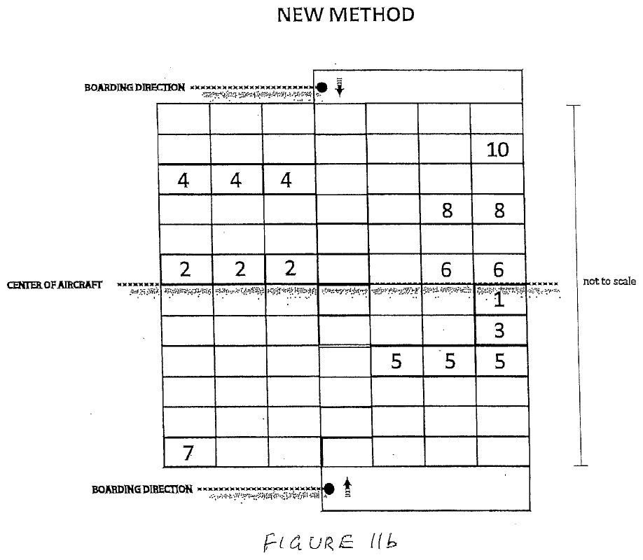

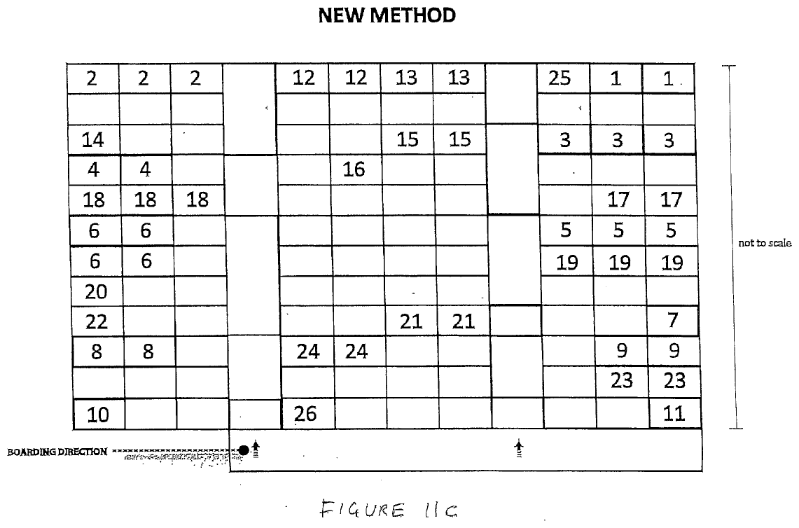

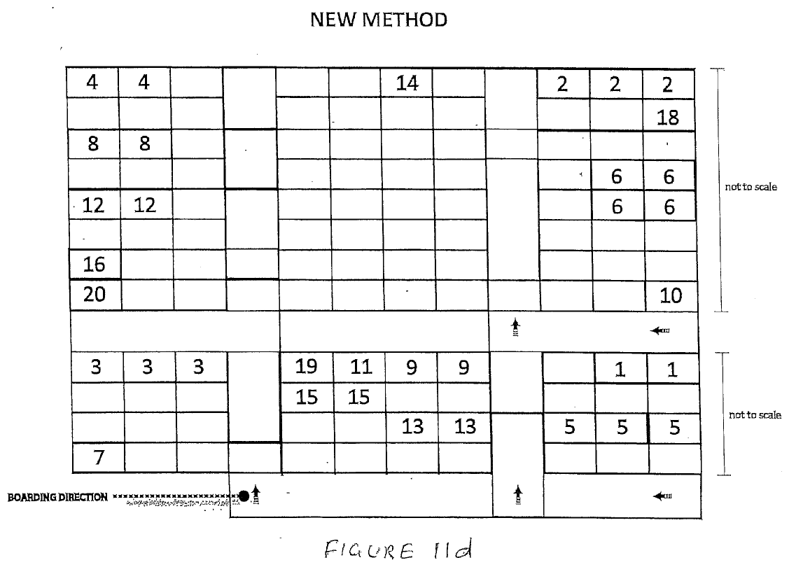

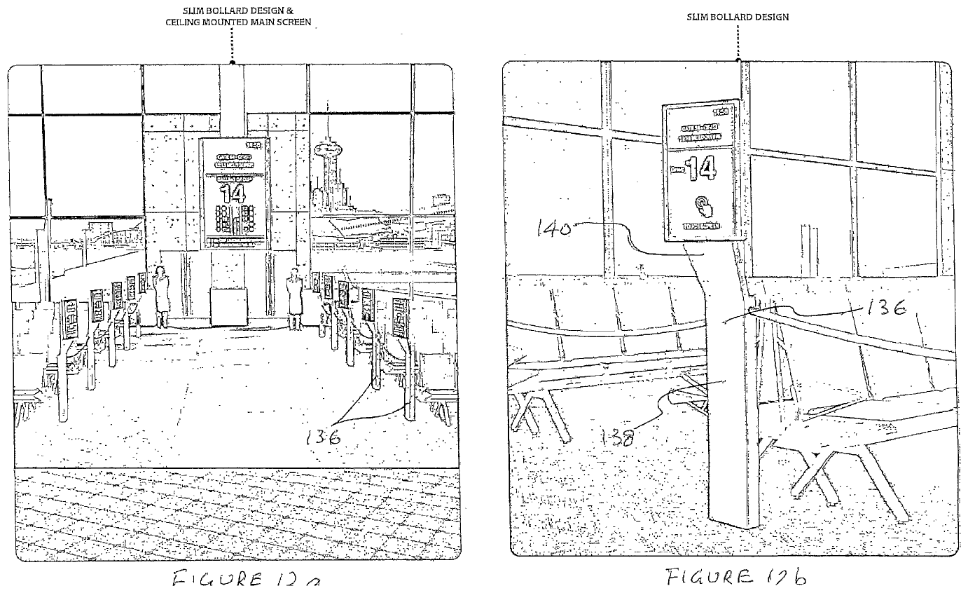

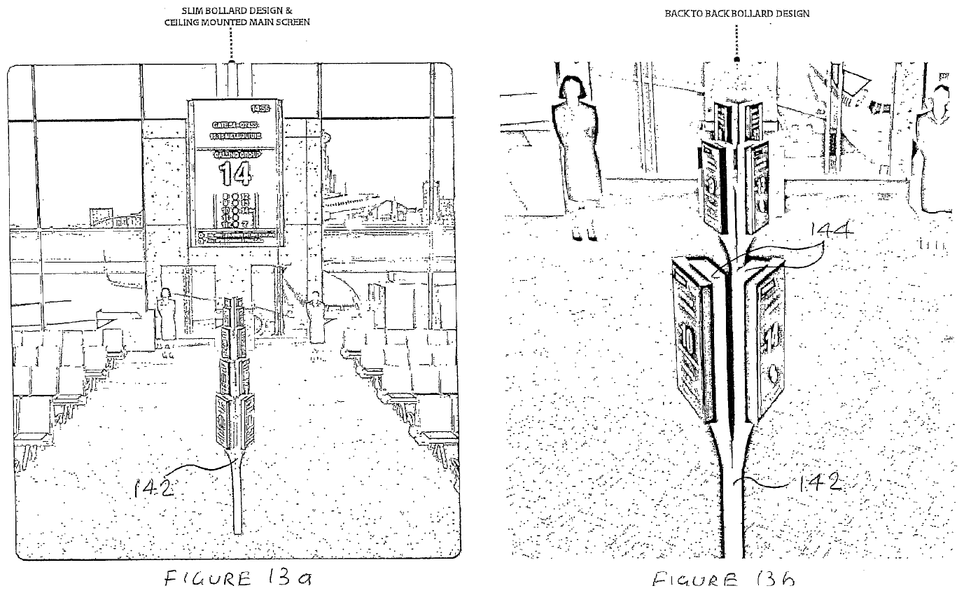

Turning back to FIGS. 5, apart from being a mobile smart phone or tablet computer, the one or more electronic devices may also take the form of one or more sizable electronic displays. By way of example, in the present embodiment, a first electronic display 128 is provided hanging off a steel member 130 extending downwardly from the ceiling. In the present embodiment, the electronic display 128 being the main screen is located in close proximity to the boarding pass checking counter, as illustrated in FIG. 5. In addition, referring to FIG. 10, a second electronic display 132 is provided hanging off a pole 134 which extends downwardly from the ceiling. The second electronic display 132 is located somewhere in the middle of the boarding bays 118 being 3-sided such that the displayed information, particularly the group number currently being called, may be readily visible from any angle. As an alternative embodiment, displays 128 and 132 may be combined into one 3-sided screen that hangs from the ceiling. Such a screen may be located above one of the communication points where it is most visible and appropriate for the entire lounge. The electronic display 132 may also be supported by a supporting structure in the form of a tower 148, as shown in FIG. 14. It should be noted that further electronic displays may be provided at different locations in the vicinity of waiting area depending on spatial parameters of the different airports. For instance, multiple additional electronic displays (not shown) may be mounted on window frames surrounding the waiting area. The electronic displays 128 & 132 are capable of displaying information in a font that can be seen at a distance. The displayed information most importantly includes a group number which is currently being called so as to prompt the group of passengers assigned the shown number to go to a designated communication point 116. As best shown in FIGS. 5 and 10, the displayed information also includes graphical directions to the designated communication point 116.

In the present embodiment, the processor may be programmed to handle various groups of passengers in batches distinguished by at least the three common classes of travel, namely economy, business and first class. It will be appreciated that the processor may be programmed to handle additional classes depending on the needs of the user. As shown in FIG. 15a, the electronic display 128 shows Group 14 which is being called to the corresponding communication point. Group 14, as an example, belong to the economy class which is usually the last batch to board. If, for whatever reason, a group that belongs to the first or business class turns up at the boarding gate while the economy batch is being handled, the first or business class group may proceed to boarding bypassing the currently called Group 14 as a privilege for being in the first or business class. As shown in FIG. 15b, a first class passenger 150 who can board at any time is bypassing all the communication points proceeding straight through to boarding pass check during economy boarding.

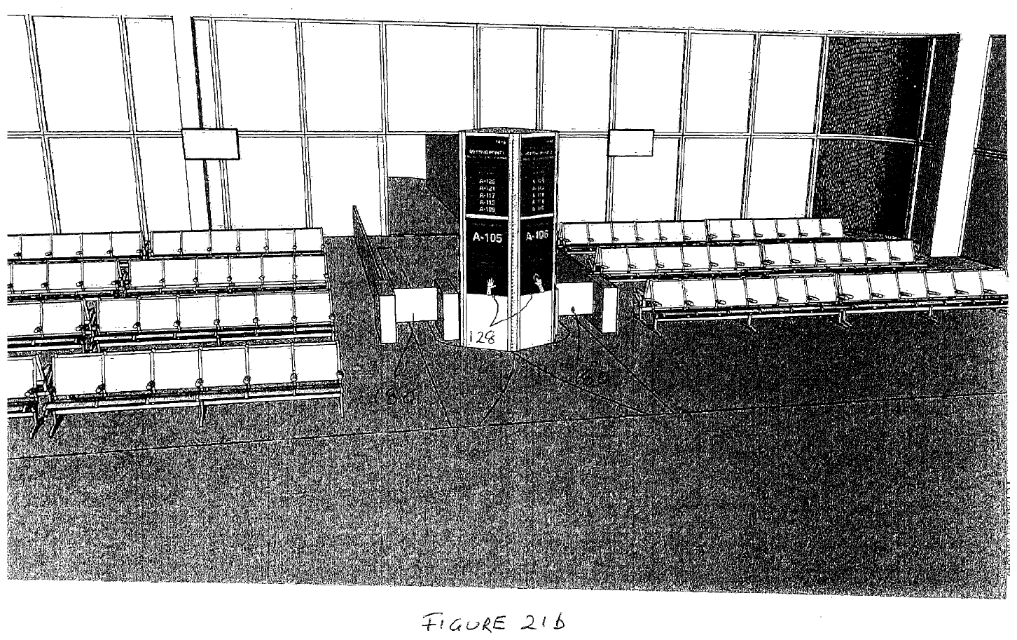

Turning now to FIG. 17a, another embodiment of bollards 136a is provided. Each bollard 136a includes a circular screen 172 at the top which is configured to display and call numbers. Each bollard 136a also includes bottom screen 174 adapted to interface with passengers. Referring to FIG. 17b, the bollards 136b are located at alternative positions by the windows 176. Also, as shown in FIG. 17a, a designated priority boarding queue 178 is provided for priority boarding. For instance, first class passengers who are allowed to board at any time bypassing all the communication points proceeding straight through to boarding pass check as a privilege.

Referring to FIG. 18a, in a further alternate embodiment, each bollard 136a is operably associated with a gate 180 which is designed to allow passengers to go through on completion of the passenger verification, validation and coordination (and possibly authentication) process. As shown in FIG. 18b, the bollards 136a and gates 180 are provided at a different location being the centre of the waiting area.

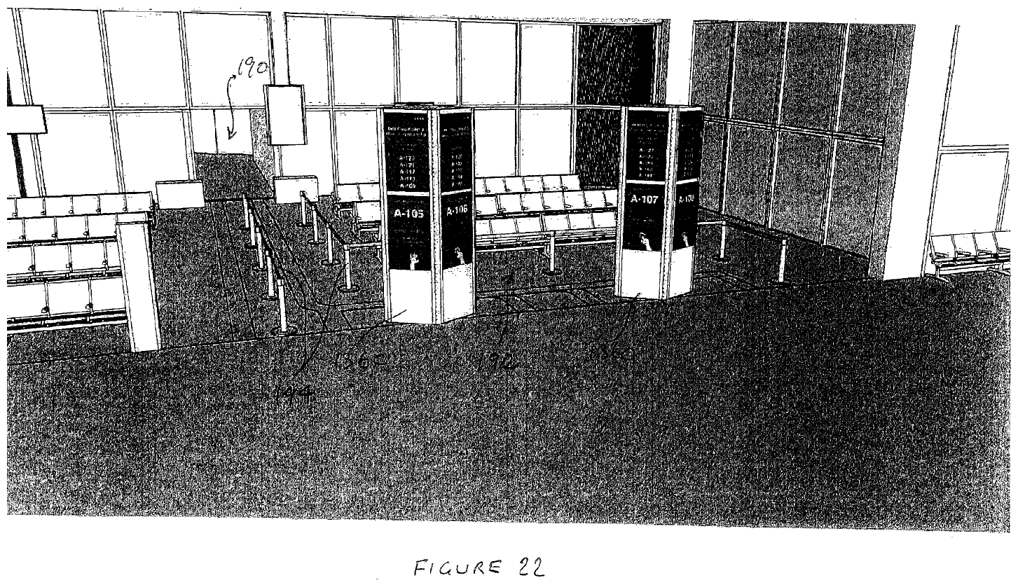

Referring to FIG. 19, it is contemplated that for some airports or facilities, no verification at communication points is required. In such a circumstance, individual communication points 116 will not be provided and passengers will be called only by electronic display 128 having the large main screen which is programmed to display or call numbers so as to notify passengers belonging to respective passenger groups to go straight on board. In the present embodiment, the electronic display 128 is provided at a chosen central location visible to all passengers in the waiting area.

It will be appreciated that electronic colour coding is used on all touch screens at all communication points to differentiate first and business classes from the economy class. Referring to FIG. 15c, for example, a touch screen 148 is shown with a black background colour to signify that the currently called Group 7 belongs to first or business class.

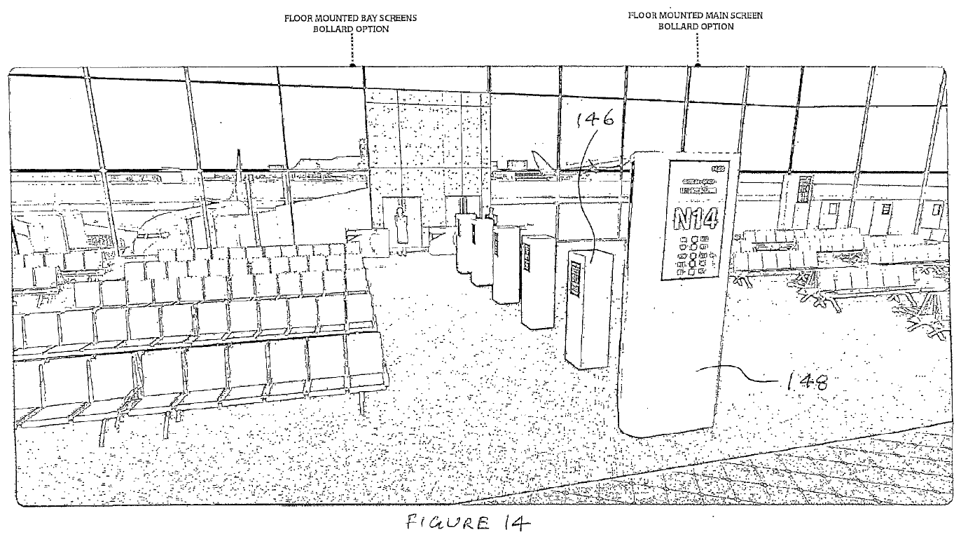

Referring now to FIGS. 11a to d, examples of how groups of passengers are ordered are illustrated. It can be observed that groups of passengers are calculated by the processor to board the aircraft in different orders depending on the flight characteristics, ie. aircraft type, door access parameters and cabin layout. The shown examples illustrate the boarding orders and boarding directions for aircrafts that are catered for single door loading, double door loading, two-aisle loading with a single door and two-aisle loading with double door, respectively. It will be appreciated that there are various seating layouts, door and accessibility variations for different aircrafts and the boarding order is applicable to all of these variations.

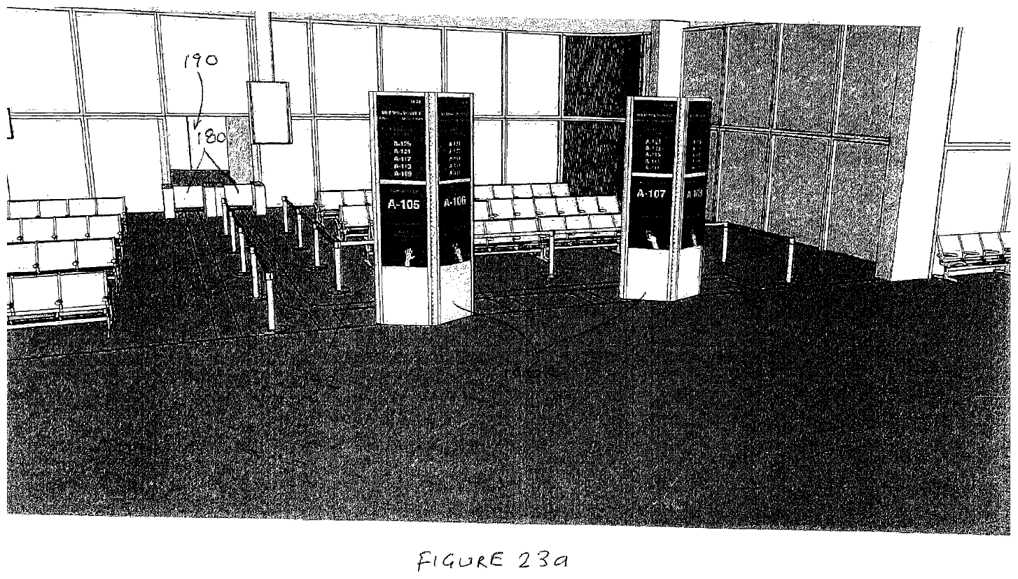

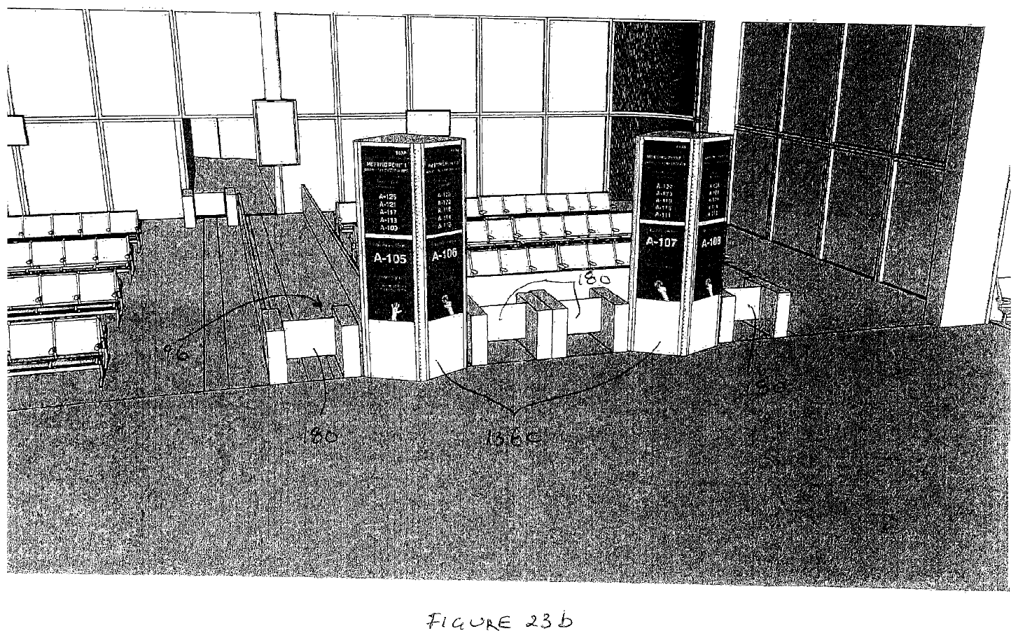

Turning now to FIG. 20, a bollard 136c being a further embodiment is shown. In this embodiment, the bollard 136c has two pairs of electronic displays 128, each pair having a top one stacked on top of a bottom one. The two bottom ones are configured to provide two independent communication points. In this embodiment, the two pairs of electronic displays 128 are disposed at an angle to one another facing different directions. This allows two different groups of passengers to be called and processed simultaneously. Also, each of the top electronic displays 128 shows a schedule of references or codes 204 next to be called in a sequence. As such, groups of passengers that are in waiting would be able to peek ahead and figure out approximately when they can expect to be called. Referring to FIGS. 21a and b, each of the bottom electronic displays 128 is operably associated with a gate 180 designed to allow passengers to go through on completion of the passenger verification, validation and coordination (and possibly authentication) process. In two different embodiments, the gates 180 are located at the entrance of the passageway 190 as shown in FIG. 21a and next to the respective corresponding electronic displays 128 as shown in FIG. 21b.

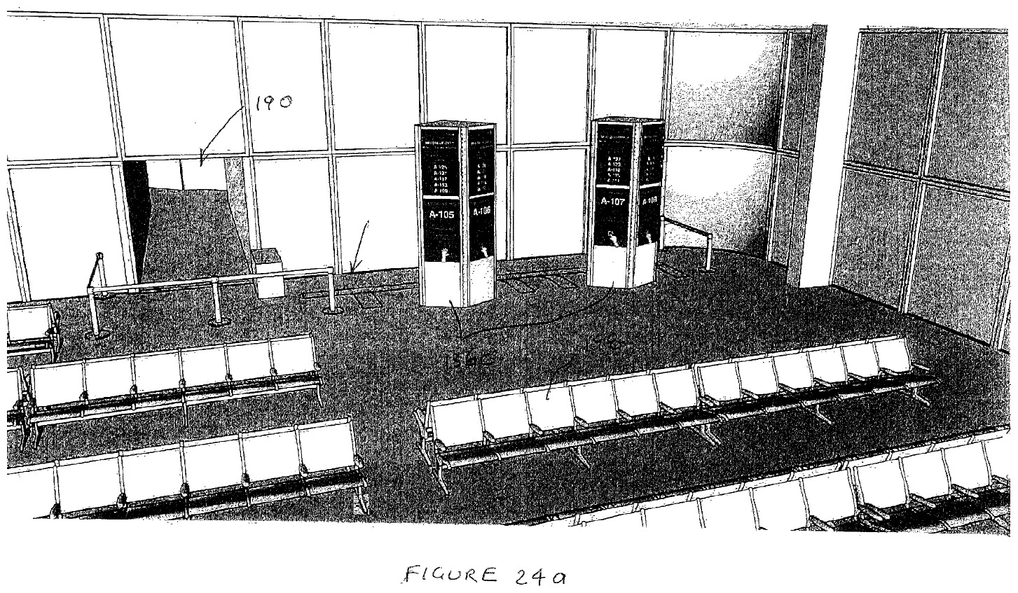

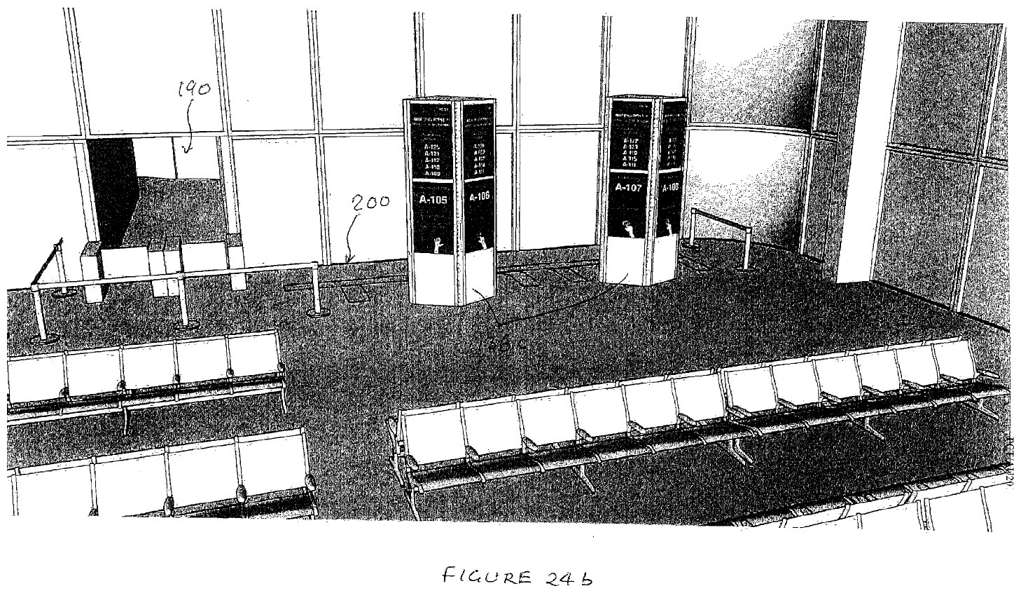

Referring to FIG. 22, two bollards 136c are available for use providing four communication points. Behind the two spaced apart bollards 136c is a walkway 192 defined by stanchions and crowd control barriers 194 provided to guide passengers towards the entrance of the passageway 190. As shown in FIG. 23a, the bollards 136c are operably associated with the gates 180 which are located at the entrance to the passageway 190. Referring to FIG. 23b, the gates 180 are adjacent to the bollards 136c partly forming a walkway as a restricted zone.

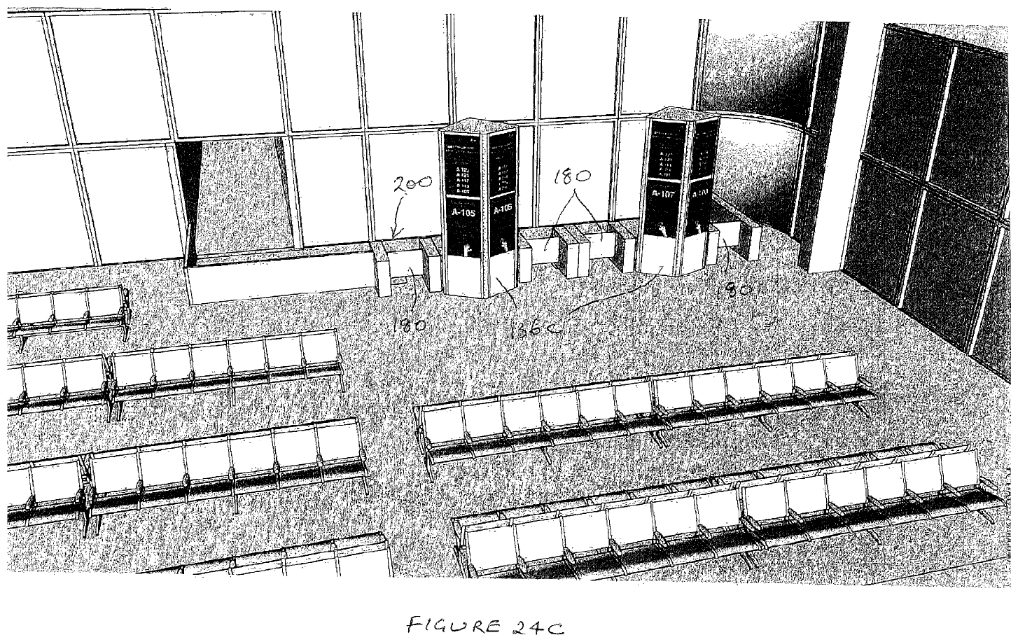

Turning to FIG. 24a, the bollards 136c are located behind seats 198. Behind the bollards 136c is a walkway 200 which leads to the entrance to the passageway 190. As shown in FIG. 24b, gates 180 operably associated with the bollards 136c are provided at the entrance to the passageway 190. Referring to FIG. 24c, the gates 180 are located adjacent to the two spaced part bollards 136c thereby forming a barrier to the walkway 200.

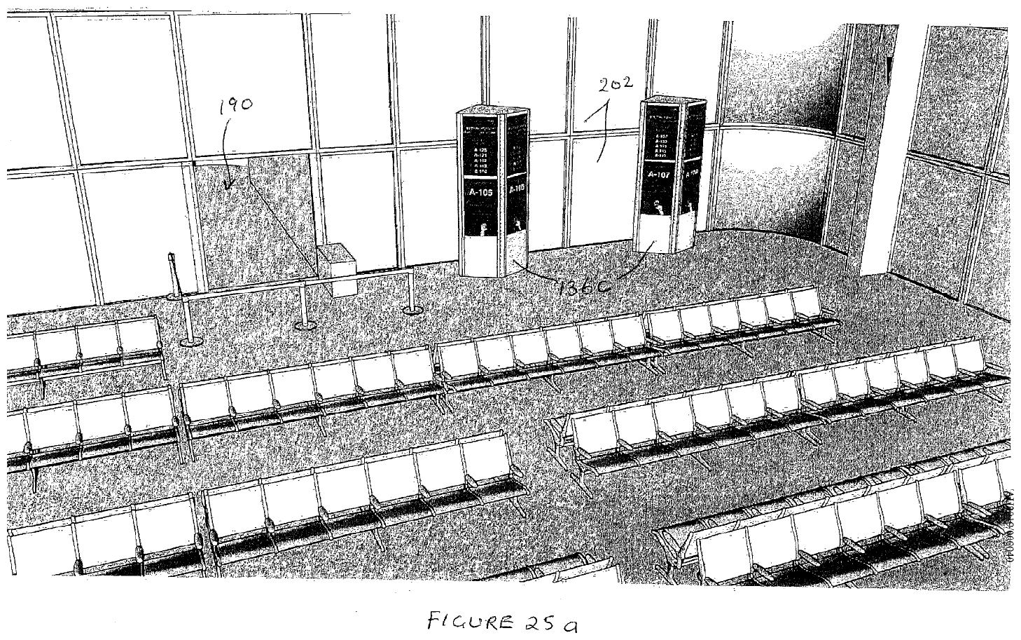

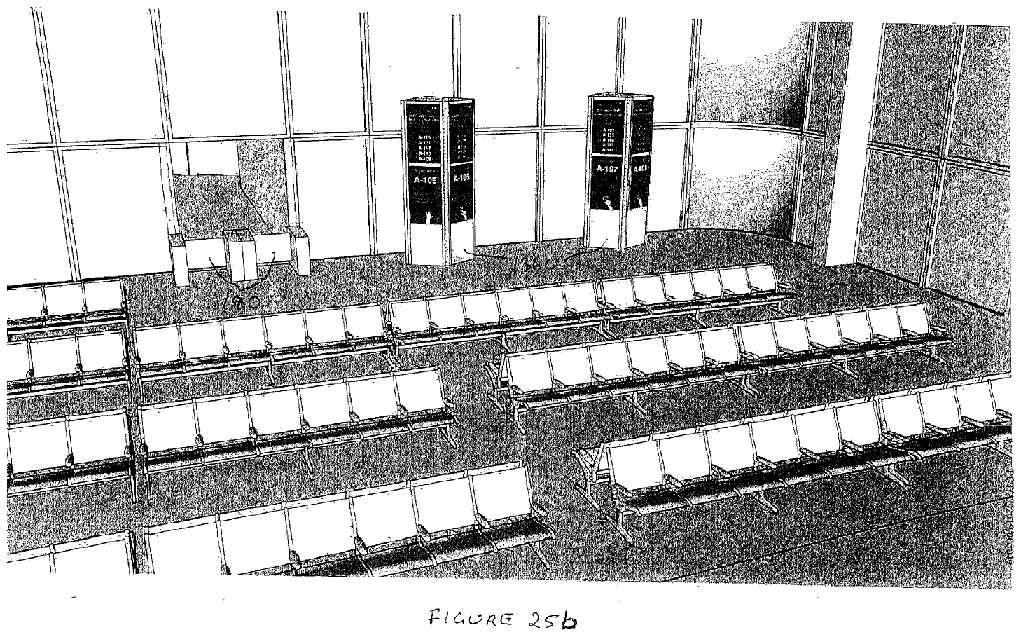

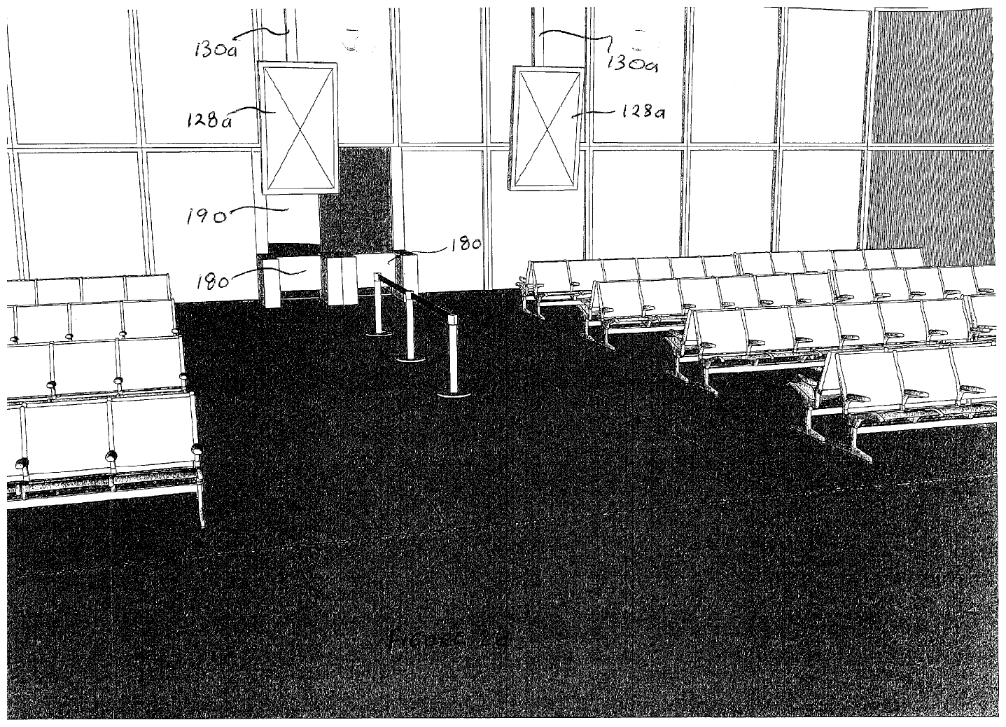

Referring to FIG. 25a, the bollards 136c are provided right in front of the windows 202 which means that passengers will have to proceed sideway to head to the entrance of the passageway 190 upon completion of processing. This configuration and arrangement would suit airports with a relatively small waiting area. As shown in FIG. 25b, gates 180 operably associated with the bollards 136c are provided at the entrance to the passageway 190.

Turning back to FIG. 20, being generated from an alternative referencing system, the boarding group references or codes 204 shown in the electronic displays 128 take a different format from that simple number ‘14’ shown on the screen of the electronic display in FIG. 5 for example. This alternative numbering system consists of two parts, the first part being a letter and the second part a numeral. Also, the numbers or numerals need not be consecutive. For example, a schedule of references or codes may have a sequence including A-101, A-103 and A-105 etc for example.

The optimised boarding order is calculated in such a way that each group of passenger(s) is allowed a pre-determined number of rows of clear space inside the cabin during boarding based on the abovementioned passenger characteristics. Referring to FIG. 11a, five examples demonstrating how groups of passengers with different characteristics are ordered to board by the processor of the system of the present invention are given below:

Example 1—A group has three passengers with a pram, a baby and children. The seating assignment obtained from the relevant airline indicates that they are to be seated towards one end of the cabin. Based on these characteristics, the processor following the programmed algorithm has calculated that this group should be the first group to board with four rows 152 of clear space allowed for boarding.

Example 2—This group has only one passenger with a small carry-on baggage only and as a result of the calculation, only one row 154 of clear space is allowed for boarding.

Example 3—This group has two passengers who are seated separately in the same row with one small carry-on baggage only and as a result of the calculation, two rows 156 of clear space are allowed for boarding.

Example 4—This group has two passengers who are seated next to one another with one large carry-on baggage and as a result of the calculation, three rows 158 of clear space are allowed for boarding.

Example 5—This group has three passengers including an elderly person and being seated separately and as a result of the calculation, the equivalent of four rows 160 of clear space are allowed for boarding.

The above groups may be called individually and independently, or combined and called as one large group.

It is contemplated that, notwithstanding the above, the calculating algorithm is programmed to allow special arrangements and orders to be made to suit larger groups which will need more clear space to pass each other. Also, if the system 100 is notified of any seat or aisle interference, more clear space and time can be added. It is also contemplated that system 100 will identify seat or aisle interferences caused by the grouping of passengers. The system may choose to delay any particular group's boarding in the sequence to reduce or alleviate seat or aisle interfaces or any existing congestion caused thereby. For instance, it is contemplated that the system 100 may allocate passenger ‘pull over’ space by delaying passenger groups with aisle seats. In doing so, it enables other passengers to pass one another. Furthermore, groups with a high number can be allocated more clear space if necessary due to minimal overhead baggage space. The adjustments may be made according to the circumstances if and when necessary by way of the boarding times shown on the electronic interfaces which are used as a control of the passenger boarding flow dictated by the algorithm. There exists a time interval between the boarding times of any two consecutive groups. The time interval being controlled by the processor may vary depending on the flow of passengers during boarding. For example, the time interval between groups 1 and 2 being called may be different from that between groups 8 and 9.

It is contemplated that system 100 may include video object recognition technology to further control boarding timing between groups. For example, a person who has recently been injured and is on crutches, requires more time to arrive at his or her allocated seat. Under such a circumstance, system 100 is capable of identifying and slowing down the boarding timing on the subsequent groups. Furthermore, video object recognition being processed by system 100 may also identify and quantify a group's baggage amount and a group's walking speed. As such, system 100 can then speed up or slow down the boarding time of subsequent groups accordingly.

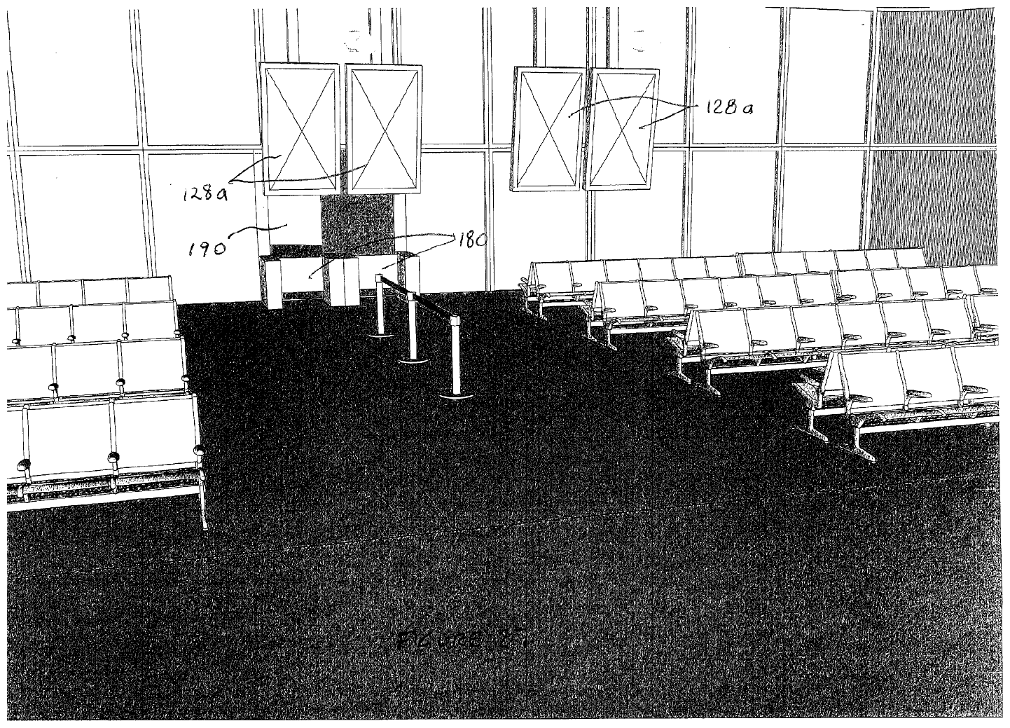

Referring to FIG. 26, in an alternate embodiment, a pair of electronic displays 128a hanging off the ceiling by way of respective steel members 130a is shown. The electronic displays 128a are located in the vicinity of the passageway 190. Similar to the electronic display 128 shown in FIG. 20, each of the electronic displays 128a shows the number or group being called as well as a schedule of references or codes next to be called in a sequence. Optionally, each electronic displays 128a is operably associated with a gate 180. It is contemplated that each gate 180 may be a turnstile or baffle gate which is adapted to restrict access to one authorised passenger at a time. In this embodiment, each electronic displays 128a has a built-in transponder unit which is configured to interact with certain electronic devices such as a smart phone of a passenger. The transponder is a wireless communications, monitoring and control device that picks up and automatically responds to an incoming signal transmitted from the smart phones of passengers. An example is an RFID (radio frequency identification) device or Bluetooth. As such, the transponder allows the system 100 to identify each passenger or group of passengers that walks underneath or past the relevant electronic display 128a before entering into the passageway 190.

Each transponder unit also has a sensor that is designed to decode and transcribe the information the transponder contains. It is contemplated that the sensor is configured to facilitate passenger counting, facial recognition and movement detection. The transponder unit can be hidden within each electronic display 128a and its information can be sensed up to several metres away. The transponder may interact with passengers' smart phones via Bluetooth technology for example. The transponder unit is electronically associated with the system 100 so as to form a feedback loop. As such, the system 100, being able to receive real time feedback information from the transponder unit, is able to track numbers that have been missed and have the option of triggering the calling of one or more following numbers in the sequence.

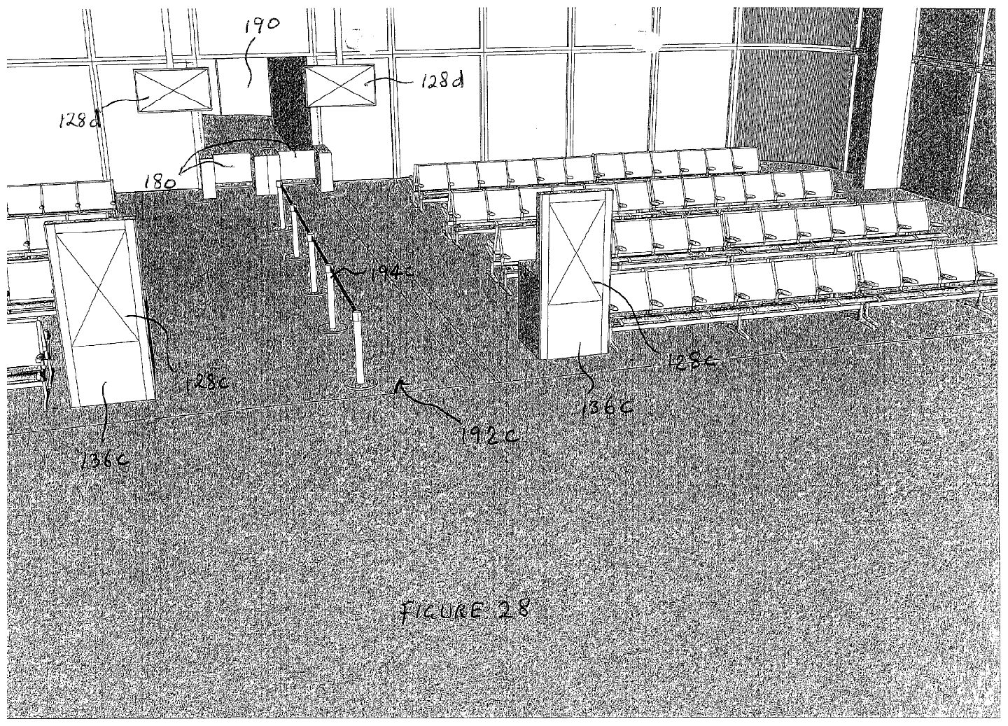

The system 100 is also designed to send text messages or notifications to individual passengers to provide boarding updates. Each text message may include link to an App or a website which provides a countdown facility so as to keep passengers informed of when they can expect to be called or prompt them to rush to the relevant boarding gate as a matter of urgency. Turning to FIG. 27, in a further embodiment, two pairs of electronic displays 128a are provided. The first pair is provided above the entrance to the passageway 190 and the second pair located in front of a seating area. Each pair of electronic displays 128a has two screens, one for displaying the number being called and the other for displaying the schedule of references or codes in a sequence. Again, optionally, a pair of gates 180 operably associated with the electronic displays 128a is provided at the entrance to the passageway 190.

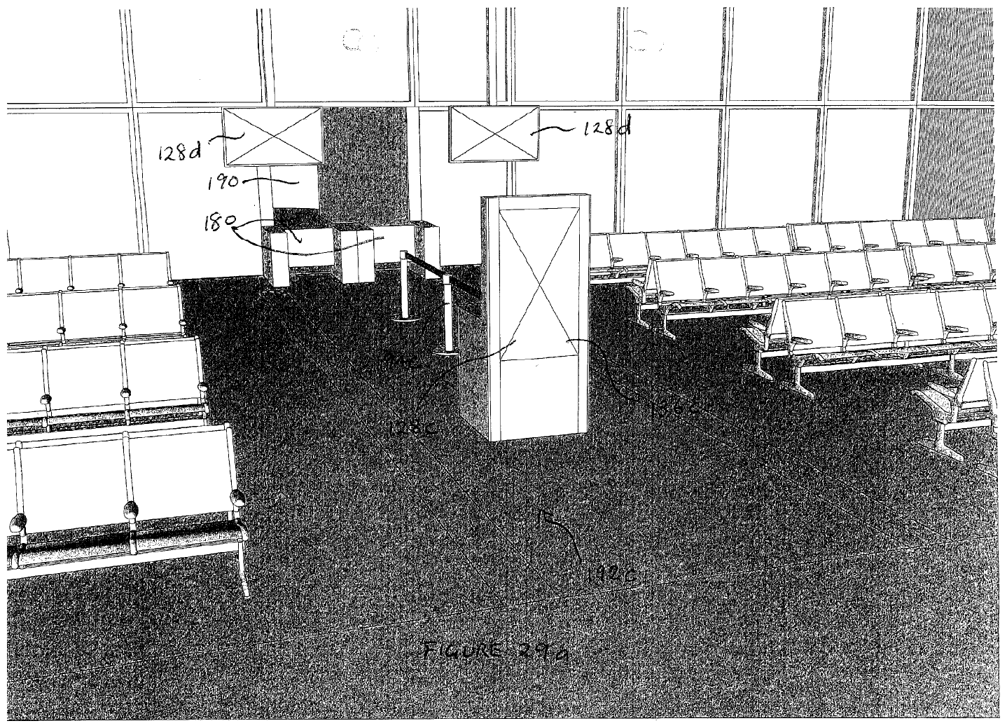

Referring to FIG. 28, in a yet further embodiment, a pair of bollards 136c is provided flanking the walkway 192c which is divided by a crowd control barrier 194c. Optionally, this embodiment may also include a pair of hanging electronic displays 128d located in close proximity to the entrance to the passageway 190. In this embodiment, the electronic displays 128d are disposed horizontally displaying the same information as those shown in electronic displays 128c. Once again, it is optional to provide gates 180 which are operably associated with the electronic displays 128c and 128d. It should be noted that each bollard 136c in this embodiment is mobile being equipped with castor wheels (not shown). As such, the bollards 136c may be moved to other locations as desired. Also, such mobile bollards 136c are designed to be empowered by one or more rechargeable batteries.

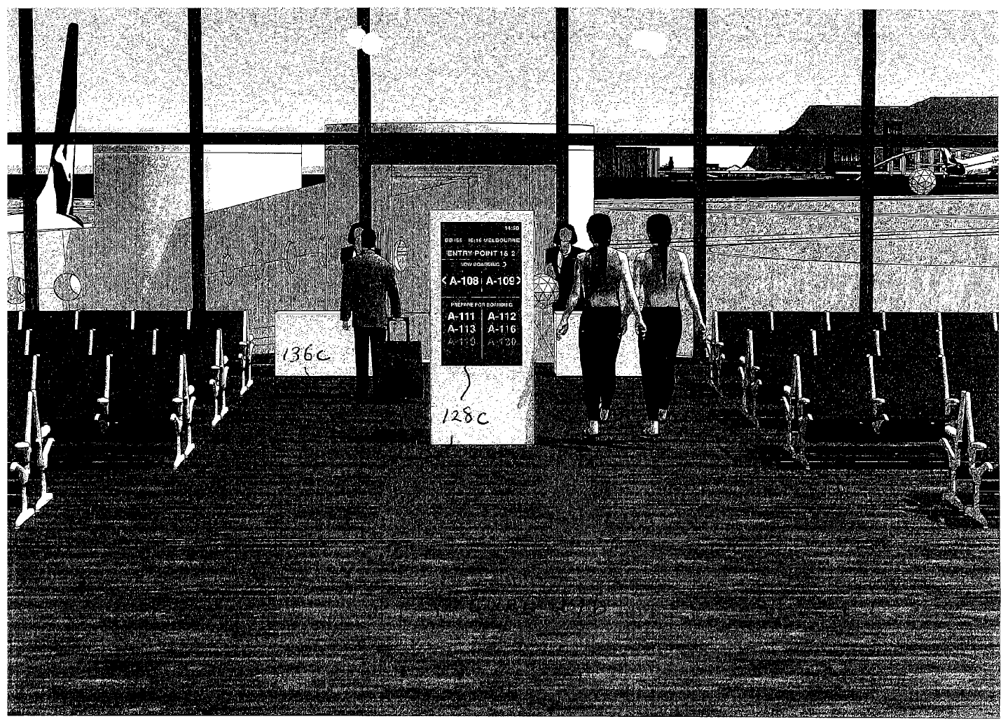

As shown in FIG. 29a, in a yet further embodiment, only one bollard 136c is provided in the middle of the walkway 192c divided by barrier 194c. The electronic display 128c however is capable of showing two numbers being called and two schedules of references or codes. This allows two groups of passengers to be called for boarding simultaneously. Again, optionally, two hanging electronic displays 128d and two corresponding gates 180 may be provided at the entrance to the passageway 190.

It should be noted that the embodiments illustrated in FIGS. 26 to 27 do not include any communication points, touch screens or the like. Furthermore, each of the electronic displays 128a, 128c and 128d may include an audio facility such as a loud speaker which enables vocal announcement of the relevant number to be called thereby prompting the relevant passengers to board.

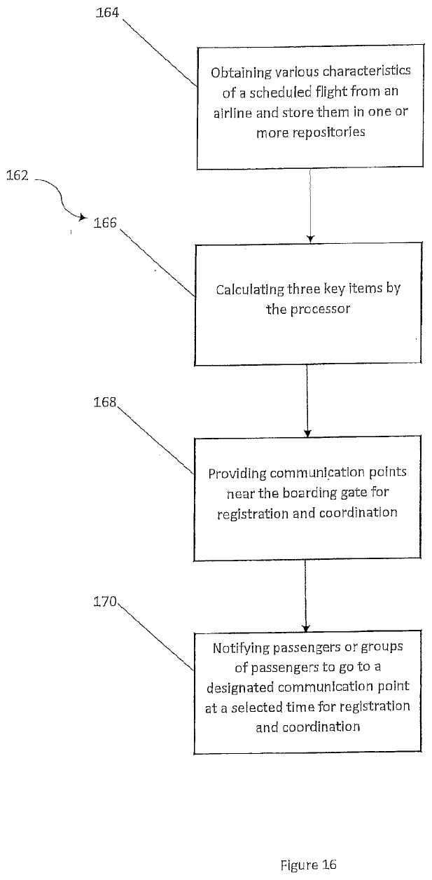

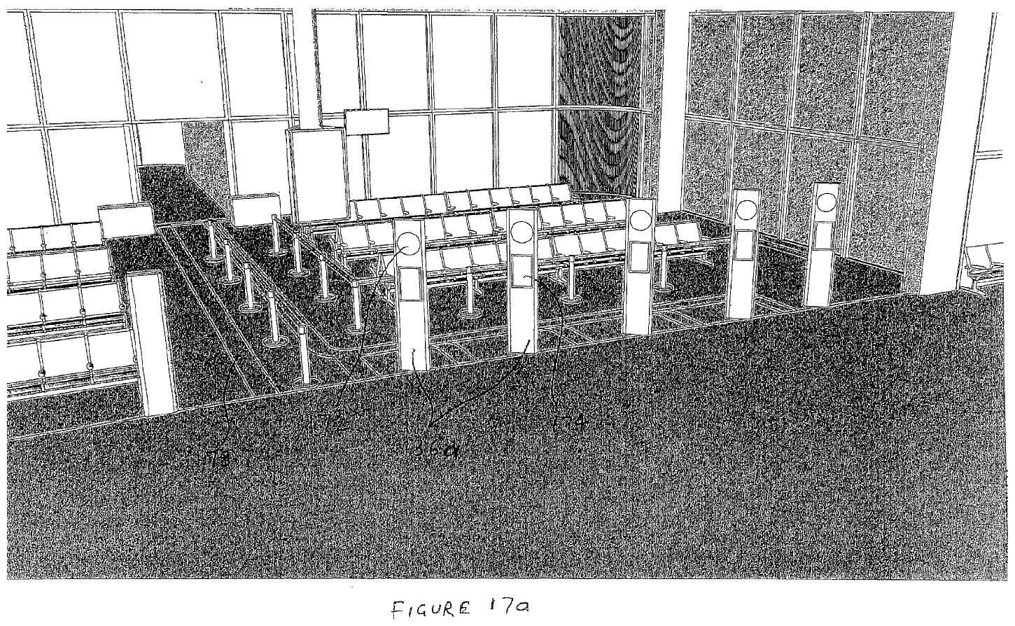

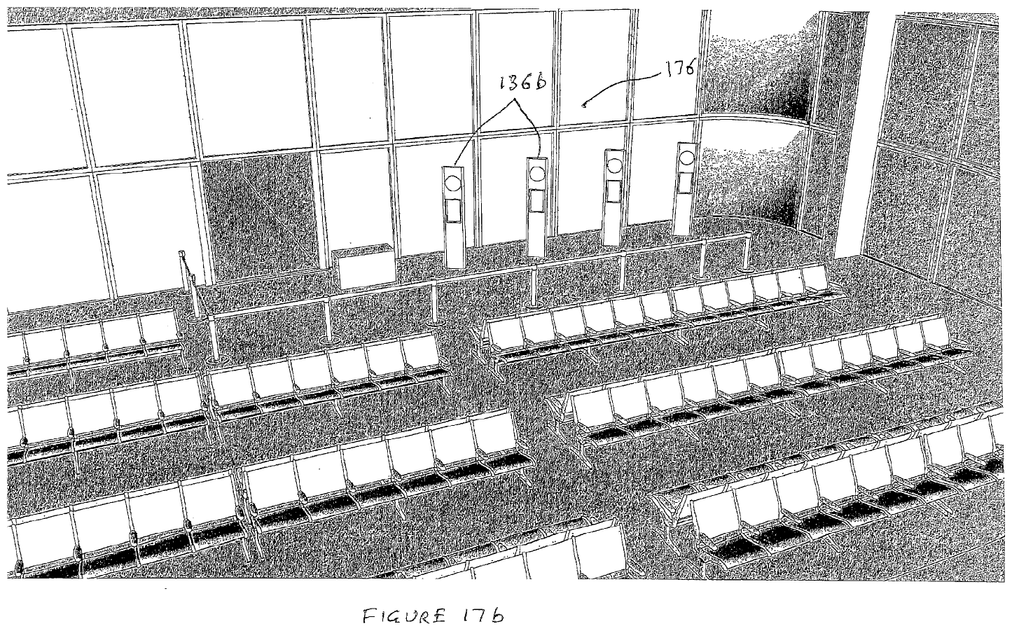

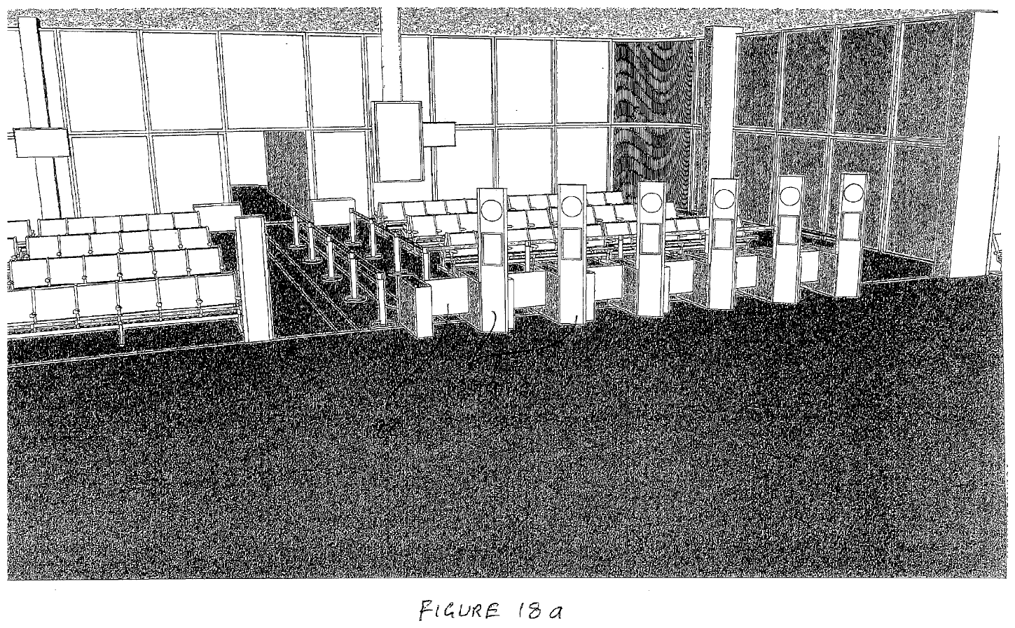

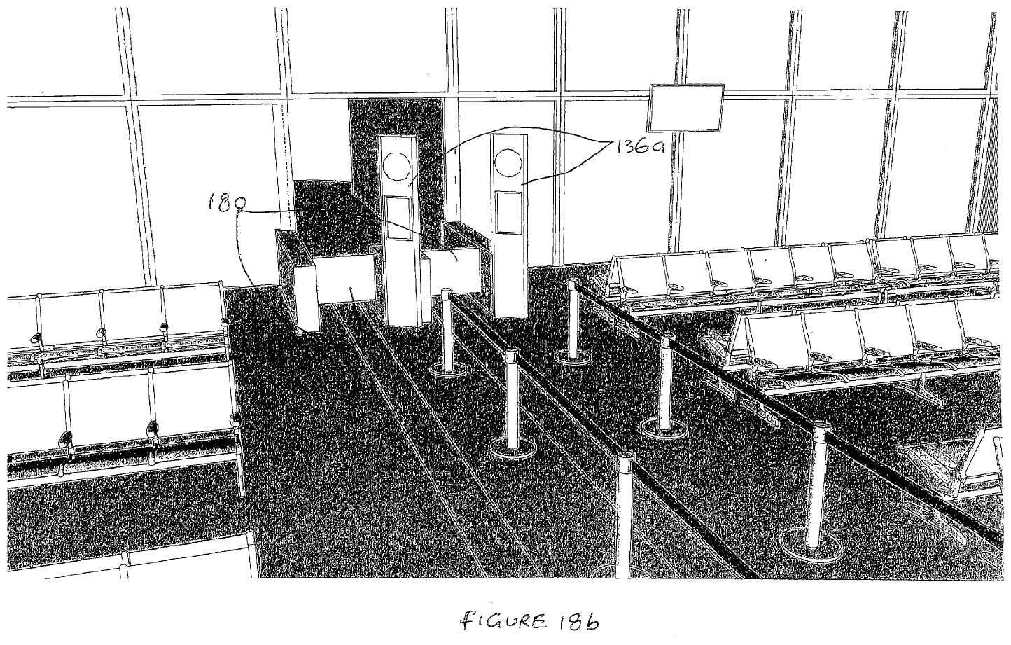

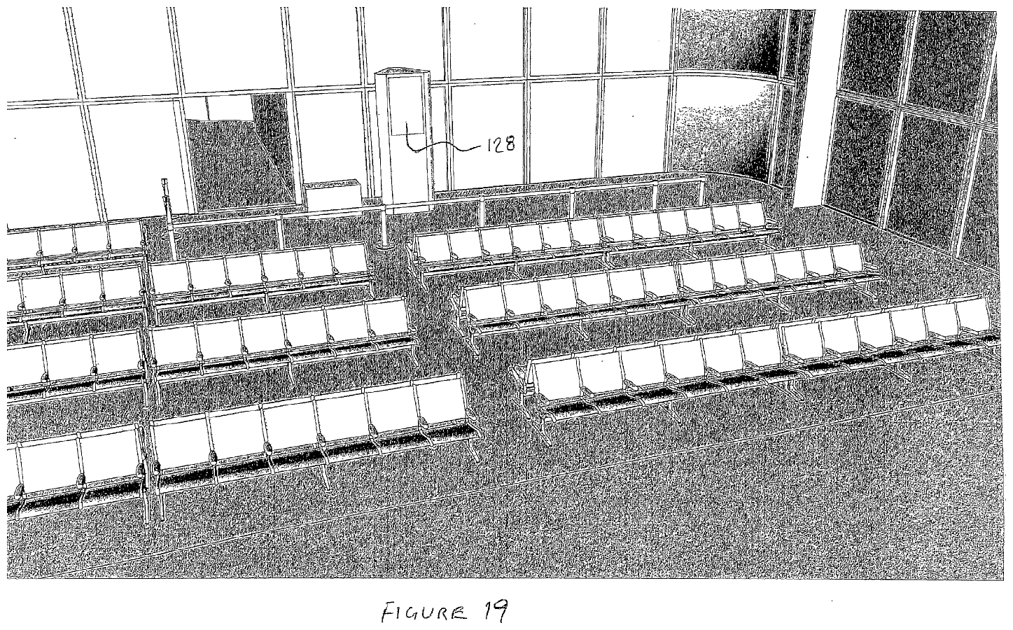

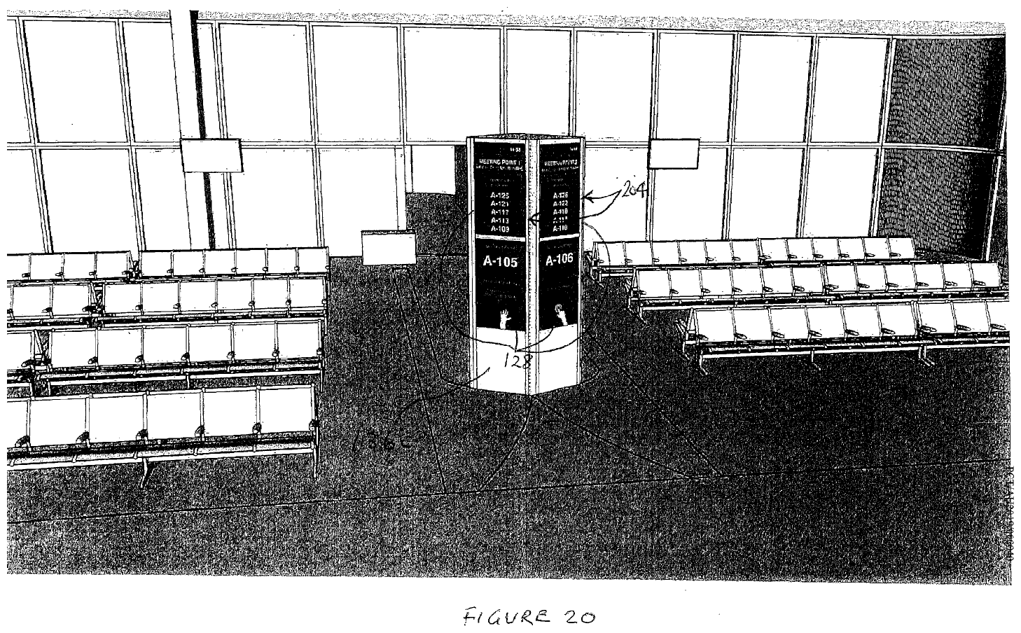

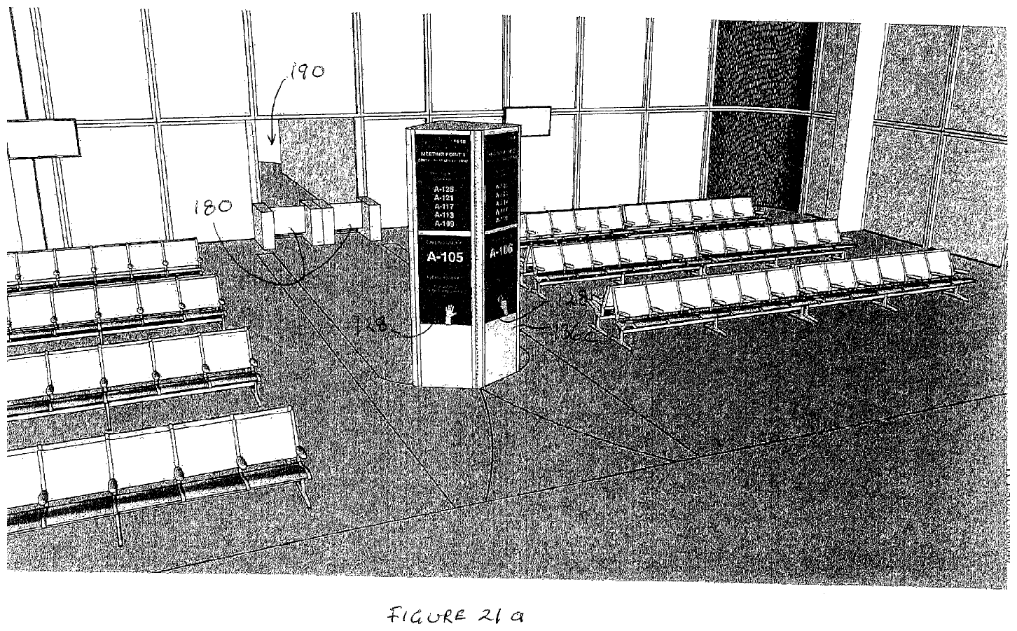

A method 162 for boarding an aircraft will now be explained with reference to FIG. 16.

At step 164, a system administrator 110 creates one or more repositories for storing passenger, booking and passenger carrier characteristics of a specific scheduled flight obtained from an airline.

At step 166, a processor with a programmed algorithm calculates a) grouping of one or more passengers boarding the aircraft; b) an optimised boarding order; c) boarding times for every group of passengers, based on the aforementioned characteristics. It should be noted that the calculations for a), b) and c) need not be carried out in any particular order or sequence.

At step 168, the system administrator 110 provides a number of communication points (in the vicinity of a relevant boarding gate) at which passengers are registered and coordinated based on the calculated boarding times and order.

At step 170, each passenger or groups of passengers is notified through one or more electronic devices to go to one of the communication points at a selected time for registration and coordination in preparation for boarding. It will be appreciated that the electronic devices may be mobile smart phones or tablet computers as well as large electronic displays affixed to selected locations in the vicinity of the relevant boarding gate near all the communication points.

Now that various preferred embodiments of the present invention have been described in some detail, it will be apparent to a skilled person in the art that the boarding system and method of the present invention may offer at least the following advantages:
1. they enable time saving on boarding;
2. they facilitate reduction in airlines' and airports' operating costs;
3. they increase passenger satisfaction as a result of waiting time reduction at the boarding gate;
4. they increase aircraft and airport utilisation;
5. they enable the flight attendants to have total control of the timing and flow of processing passengers for boarding;
6. they facilitate reduction in or elimination of aisle and seat interferences or bottleneck waiting on board the plane; and
7. they enable reduction of fuel consumption which leads to emission reduction.

Those skilled in the art will appreciate that the invention described herein is susceptible to variations and modifications other than those specifically described. For instance, the system 100 may have a user interface whereby staff can control the functionality of the system. As such, the staff would be able to manually start, pause and stop the system 100 if necessary. Also, the system 100 may have a repository where staff can validate reasoning to advance or delay the boarding process necessitated by unexpected situations such as delays on the part of the cleaning crew. In such a circumstance, the staff can request that the boarding process be delayed and enter a reason into the system 100. Furthermore, it is contemplated that the four electronic displays 128 shown in FIG. 20 may be consolidated into one large display screen. All such variations and modifications are to be considered within the scope and spirit of the present invention the nature of which is to be determined from the foregoing description.

1-23. (canceled)

24. A boarding system comprising:
one or more repositories for storing passenger, booking and passenger carrier characteristics of a specific scheduled journey in a specific passenger carrier;
a processor configured to calculate grouping of one or more passengers boarding the passenger carrier and an optimized boarding order, and to allocate an exact boarding time to each passenger of every group of passenger(s) based on one or more of said characteristics and the optimized boarding order; and
one or more electronic devices through which each passenger or group of passengers is notified to go on board,
wherein the processor is programmed to proactively communicate the allocated boarding time individually and independently to each passenger of every group of passenger(s) via the one or more electronic devices.

25. The boarding system of claim 24, wherein grouping involves the processor allocating a reference or code to selected one or more passengers who are to board at the same time.

26. The boarding system of claim 24, wherein there exists a time interval between the boarding times of any two consecutive groups, the time interval which is controlled by the processor is adapted to vary depending on the flow of passengers during boarding.

27. The boarding system of claim 24, wherein the optimized boarding order is calculated in such a way that each group of passengers is allowed a pre-determined number of rows of clear space inside the cabin during boarding based on passenger characteristics.

28. The boarding system of claim 24, wherein the processor is configured to follow an algorithm which performs calculation by assessing said characteristics.

29. The boarding system of claim 27, wherein the passenger characteristics include age, carry-on luggage, co-traveler information, physical or mental impairments, care requirements, vision problems, disabilities or mobility issues, travelling with wheelchairs for the elderly, travelling with prams, carriers or capsules for babies or strollers for toddlers.

30. The boarding system of claim 24, wherein the booking characteristics include check-in status and travel classes.

31. The boarding system of claim 24, wherein the passenger carrier characteristics include aircraft type, door access parameters, cabin layout and seat assignment.

32. The boarding system of claim 24, wherein the processor is configured for delaying any particular group's boarding in the optimized boarding order to reduce or alleviate seat or aisle interfaces or any existing congestion caused thereby.

33. The boarding system of claim 24, wherein the process is capable of allocating passenger ‘pull over’ space by delaying passenger groups with aisle seats.

34. The boarding system of claim 24, wherein the one or more electronic devices include a smart phone, a smart watch, a tablet computer and any near-field communicated (NFC) enabled devices.

35. The boarding system of claim 24, wherein an SMS, notification or email message is sent to each passenger or group of passengers with a link to a portal or to a downloadable app which is configured so as to provide each passenger or group of passengers with a primary trigger to boarding.

36. The boarding system of claim 35, wherein the primary trigger includes an electronic countdown to boarding facility.

37. The boarding system of claim 36, wherein the countdown to boarding facility is displayed on the electronic device of each passenger or group of passengers.

38. The boarding system of claim 37, wherein the system is configured to be capable of controlling the accessibility, visibility and availability of an electronic ticket, QR code and any NFC.

39. The boarding system of claim 24, wherein each group is called individually and independently, or two or more groups are combined and called as one large group.

40. The boarding system of claim 24, further comprising a user interface configured to facilitate manual control of its functionality.

41. The boarding system of claim 24, further comprising a repository configured to enable validation of reasoning to advance or delay the boarding process.

42. A boarding system comprising:
one or more repositories for storing passenger, booking and passenger carrier characteristics of a specific scheduled journey in a specific passenger carrier;
a processor configured to continuously or progressively calculate grouping of one or more passengers boarding the passenger carrier, provide an optimized boarding order or update the optimized boarding order and dynamically allocate a boarding time to every group of passengers based on one or more of said characteristics and/or the updated order; and
one or more electronic devices through which each passenger or group of passengers is notified to go on board.

43. A boarding system comprising:
one or more repositories for storing passenger, booking and passenger carrier characteristics of a specific scheduled journey in a specific passenger carrier;
a processor configured to calculate grouping of one or more passengers boarding the passenger carrier, an optimized boarding order and boarding times for every group of passenger(s) based on one or more of said characteristics; the optimized boarding order being calculated in such a way that each group of passenger(s) is allowed a pre-determined number of rows of clear space inside the passenger carrier; and
one or more electronic devices through which each passenger or group of passengers is notified to go on board.
